(19) United States
(12) Patent Application Publication
(10) Pub. No.: US 2026/0045398 A1
(43) Pub. Date: Feb. 12, 2026

(54) METHOD OF DESIGNING SUBSTANTIALLY PLANAR ELECTROMAGNETIC COILS USING CURVE TORSION AS AN OBJECTIVE FUNCTION

(71) Applicant: THEA ENERGY, INC., Branchburg, NJ (US)

(72) Inventors: Michael Martin, Weymouth, MA (US); Thomas Kruger, Princeton, NJ (US)

(21) Appl. No.: 19/360,714

(22) Filed: Oct. 16, 2025

Related U.S. Application Data
(63) Continuation of application No. PCT/US24/25920, filed on Apr. 24, 2024.
(60) Provisional application No. 63/461,639, filed on Apr. 25, 2023.

(51) Int. Cl. H01F 6/06; G21B 1/05

(52) U.S. Cl. CPC H01F 6/06; G21B 1/055

(57) ABSTRACT

The present disclosure is directed to a method of generating a set of torsion-restricted free parameters which describe a design of one or more electromagnetic coils, such as for use in a stellarator. In some embodiments, the computing of the set of torsion-restricted free parameters describing the one or more substantially planar coils includes a parametrization which describes one or more non-planar coils.

### CROSS REFERENCE TO RELATED APPLICATIONS

The present disclosure is a continuation of International Application No. PCT/US2024/025920 filed on Apr. 24, 2024, which application claims the benefit of the filing date of U.S. Patent Application No. 63/461,639 filed on Apr. 25, 2023, the disclosure of which is hereby incorporated by reference herein in its entirety.

### FIELD OF THE DISCLOSURE

The present disclosure is directed to methods of generating a set of free parameters describing one or more substantially planar coils for use in a stellarator.

### BACKGROUND OF THE DISCLOSURE

Fusion is a process which can be harnessed to release the nuclear energy in abundant fuels, without emissions of greenhouse gases and with significantly lower and shorter-lived radioactive waste than conventional fission nuclear reactors. Fusion fuels fuse only at extremely high temperature, at which all materials are in the plasma state.

Magnetic fusion devices aim to confine a fusing plasma using magnetic fields. The two leading magnetic fusion approaches are the tokamak and the stellarator, both of which utilize a magnetic field which has the topology of a torus.

Stellarators have the advantage over tokamaks of operating in steady state and requiring no additional electrical current to be driven within the plasma itself. Prior stellarator designs have included non-planar electromagnetic coils which have a complex, 3D curvature. These electromagnetic coils are difficult to design, fabricate, integrate, and maintain. Some stellarator designs include electromagnetic coils which link other electromagnetic coils, akin to the links of a chain. These electromagnetic coils cannot be fabricated separately and then assembled; they must be fabricated together, which further increases the difficulty of their fabrication, integration, and maintenance.

One example of a stellarator employing complex electromagnetic coils is the Large Helical Device (LHD) experiment operated by the Japanese National Institute for Fusion Science (Yoshimura, Y., et al. 2005. Journal of Physics: Conference Series 25 (1): 189.). These electromagnetic coils are helical coils, which are non-planar and interlock the plasma and the other helical coils. These electromagnetic coils must be wound with electrical wire on-site. Stellarators employing such electromagnetic coils are termed Torsatrons or Heliotrons.

The HSX stellarator (Anderson, F. et al. Fusion Technology 27, no. 3T (Apr. 1, 1995): 273-77. https://doi.org/10.13182/FST95-A11947086) and W7-X stellarator (Beidler, Craig, et al. Fusion Technology 17, no. 1 (Jan. 1, 1990): 148-68. https://doi.org/10.13182/FST90-A29178.) comprise planar coils (130). The planar coils of W7-X and HSX do not carry current during the highest-performance plasma confinement configurations. Rather, they exist to perform experiments at off-nominal conditions. Consequently, in HSX they are called “auxiliary coils.” Notably, the planar coils (130) of both the HSX and W7-X stellarators were not designed using a numerical optimization. Rather, they were designed by placing planar coils around a plasma axis and a modular coil system.

The NCSX stellarator design (Williamson, D., et al. Fusion Engineering and Design, Proceedings of the 23rd Symposium of Fusion Technology, 75-79 (Nov. 1, 2005): 71-74. https://doi.org/10.1016/j.fusengdes.2005.06.254.) comprises non-planar encircling coils and Toroidal Field (TF) coils, where the toroidal field coils are planar and arranged in a rotationally symmetric configuration to produce a toroidally-directed magnetic field. Like the coils of the HSX and W7-X stellarators, the TF coils of the NCSX stellarator were not designed using numerical optimization. Instead, they were designed by placing identical planar coils rotationally symmetrically around a cylindrical axis.

The ZCS stellarator design (Yu, Guodong, et al. Physics of Plasmas 28, no. 9 (Sep. 2, 2021): 092501. https://doi.org/10.1063/5.0057834.) and a stellarator design published by Moroz in 1995 (Moroz, Paul E. Physics of Plasmas 2, no. 11 (November 1995): 4269-84. https://doi.org/10.1063/1.871052.) comprise planar coils which were designed using numerical optimization. In these design methods, the authors used a parametrization of the planar coils which applies exclusively to planar coils and which can not describe non-planar coils.

To-date, stellarators include coils where (i) the coils were not designed using numerical optimization (e.g., the planar coils of W7-X, HSX, and NCSX); (ii) the coils are non-planar and were designed using numerical optimization (e.g., the non-planar coils of W7-X, HSX, and NCSX); and/or (iii) the coils are planar and were designed using a numerical optimization technique utilizing a parametrization which can only describe planar coils (e.g., the ZCS stellarator; Moroz, 1995).

### BRIEF SUMMARY OF THE DISCLOSURE

The confinement of a plasma in a stellarator requires the creation of a three-dimensional magnetic field using one or more electromagnetic coils. The magnetic field produced by an electromagnetic coil depends on its shape, location, rotation, and the amount of electrical current that flows through that coil. The present disclosure is directed to systems and methods for computing a set of free parameters describing one or more substantially planar coils, such as one or more substantially planar coils for confining a plasma within a stellarator or within one or more components of a stellarator, wherein the computing of the set of free parameters describing the one or more substantially planar coils includes a parametrization which describes one or more non-planar coils. In some embodiments, the parametrization which describes one or more non-planar coils is designed to result in one or more substantially planar coils by using a successively higher weight of the torsion penalty function.

Conventionally, planar coils were designed using numerical optimization where a parametrization was utilized which could only describe planar coils. It is believed that this limited parametrization, and the non-convexity of the total objective function, caused numerical optimizers to fail to find a global optimum of the objective function. This resulted in coils which were inferior with respect to magnetic field accuracy, coil feasibility, or both. In the methods disclosed herein, substantially planar coils are designed using a numerical optimization utilizing a parametrization which can describe non-planar coils. This extended parametrization is believed to permit the numerical optimizer to find a global optimum of the objective function despite the non-convexity of that function.

A first aspect of the present disclosure is a method of generating a set of torsion-restricted free parameters which describe a design of one or more electromagnetic coils that are substantially planar, comprising: (i) obtaining a set of preliminary non-planar free parameters, where the set of preliminary non-planar free parameters describe one or more non-planar coils; (ii) obtaining a total objective function, wherein the total objective function is derived from at least two penalty functions, wherein one of the at least two penalty functions is a torsion penalty function, and wherein the torsion penalty function has an initial weight; (iii) iteratively computing one or more torsion parameters, wherein the computation of each torsion parameter of the one or more torsion parameters comprises: (i) performing a torsion-restricted numerical optimization to generate a set of candidate torsion-restricted free parameters, and (ii) computing the torsion parameter based on the generated set of candidate torsion-restricted free parameters; and (iv) selecting the generated set of candidate torsion-restricted free parameters whose corresponding computed torsion parameter is less than a predetermined threshold value for torsion as the set of torsion-restricted free parameters; wherein a first torsion-restricted numerical optimization performed is based on (i) the obtained set of preliminary non-planar free parameters, (ii) the obtained total objective function; and (iii) a predetermined numerical optimization algorithm; and wherein each subsequent torsion-restricted numerical optimization is based on (i) a revised total objective function having at least an increased weight of the torsion penalty function relative to the initial weight of the torsion penalty function in the total objective function; (ii) the set of candidate torsion-restricted parameters generated from the immediately preceding subsequent torsion-restricted numerical optimization; and (iii) the predetermined numerical optimization algorithm.

In some embodiments, the total objective function is derived from at least three penalty functions.

In some embodiments, the at least two penalty functions each correspond to a different quantity to penalize. In some embodiments, the torsion penalty function corresponds to a torsion quantity to penalize. In some embodiments, a second of the at least two penalty functions correspond to a magnetic field error quantity to penalize. In some embodiments, the different quantities to penalize are selected from the group consisting of torsion, magnetic field error, coil-to-plasma distance, coil curvature, individual coil length, total coil length, and coil-to-coil spacing.

In some embodiments, the set of preliminary non-planar free parameters are derived by performing a preliminary non-planar numerical optimization based on a set of preliminary planar free parameters and a total objective function for the preliminary non-planar numerical optimization. In some embodiments, the total objective function for the preliminary non-planar numerical optimization is derived from one or more penalty functions for the preliminary non-planar numerical optimization. In some embodiments, the one or more penalty functions for the preliminary non-planar numerical optimization each correspond to a different quantity to penalize. In some embodiments, one or more different quantities to penalize are selected from the group consisting of magnetic field error, coil-to-plasma distance, coil curvature, individual coil length, total coil length, and coil-to-coil spacing.

In some embodiments, the set of preliminary planar free parameters are derived by performing a preliminary planar numerical optimization based on a set initial planar free parameters and a total objective function for the preliminary planar numerical optimization. In some embodiments, the total objective function for the preliminary planar numerical optimization is derived from one or more penalty functions for the preliminary planar numerical optimization. In some embodiments, the one or more penalty functions for the preliminary planar numerical optimization each correspond to a different quantity to penalize. In some embodiments, one or more different quantities to penalize are selected from the group consisting of magnetic field error, coil-to-plasma distance, individual coil length, total coil length, and coil-to-coil spacing.

In some embodiments, the set of initial planar free parameters is derived by: (i) obtaining an initial planar coil design; and (ii) choosing a parametrization which can only describe fully planar coils; and (iii) parametrizing the initial planar coil design with the chosen parametrization. In some embodiments, the parameterization chosen for the preliminary planar optimization is a Fourier representation that uses mode numbers 0 and 1. In some embodiments, the initial planar design describes a set of rotationally symmetric, circular coils. In some embodiments, set of initial planar design describes a set of coils which are placed and rotated rotationally symmetrically around a common axis. In some embodiments, the initial planar coil design includes between about 2 and about 100 coils. In some embodiments, the one or more coils of the initial planar coil design have an initial radius ranging from between about 1 cm to about 500 cm.

In some embodiments, the predetermined numerical optimization is selected from a Quasi-Newton algorithm, a Levenberg-Marquardt algorithm, an Interior Point method, an Ellipsoid method, a Broyden-Fletcher-Goldfarb-Shanno algorithm, a Conjugate Gradient method, and a Gradient Descent algorithm. In some embodiments, the numerical optimization is a variation of one of these algorithms, such as L-BFGS-B, which is a limited-memory version of the Broyden-Fletcher-Goldfarb-Shanno algorithm, with bounds on the free parameters.

In some embodiments, the predetermined threshold value for torsion is 0.1/m. In some embodiments, the predetermined threshold value for torsion is 0.05/m. In some embodiments, the predetermined threshold value for torsion is 0.01/m. In some embodiments, the predetermined threshold value for torsion is 0.05/m. In some embodiments, the predetermined threshold value for torsion is 0.001/m.

In some embodiments, the computing one or more torsion parameters is performed at least twice. In some embodiments, the computing one or more torsion parameters is performed at least three times. In some embodiments, the computing one or more torsion parameters is performed at least four times.

In some embodiments, the method further comprises designing one or more substantially planar coils for the stellarator based on the set of torsion-restricted free parameters.

In some embodiments, the method further comprises computing a set of revised torsion-restricted free parameters describing one or more planar coils. In some embodiments, the computing of the set of revised torsion-restricted free parameters comprises (i) deriving a mean filament of a coil design described by the set of torsion-restricted free parameters; (ii) identifying a mean plane of the mean filament; (iii) projecting the mean filament onto the mean plane; and (iv) computing the set revised torsion-restricted free parameters which describe the projected mean filament. In some embodiments, the method further comprises designing one or more planar coils for the stellarator based on the revised set of torsion-restricted free parameters.

A second aspect of the present disclosure is a stellarator comprising: (a) a field-shaping coil system including one or more field shaping units which define a void adapted to confine a plasma, wherein each field shaping unit comprises: (i) one or more structural mounting elements; and (ii) one or more planar shaping coils disposed on a surface of the one or more structural mounting elements, wherein the one or more planar shaping coils do not interlock with each other, and where each of the one or more shaping coils do not individually encircle the plasma; and (b) a plurality of planar encircling coils which encircle and interlock the field-shaping coil system, and wherein each planar encircling coil of the plurality of planar encircling coils do not interlock with each other; wherein the plurality of planar encircling coils are described by a set of torsion-restricted free parameters, wherein the set of torsion-restricted free parameters are generated by (i) obtaining a set of preliminary non-planar free parameters, where the set of preliminary non-planar free parameters describe one or more non-planar coils; (ii) obtaining a total objective function, wherein the total objective function is derived from at least two penalty functions, wherein one of the at least two penalty functions is a torsion penalty function, and wherein the torsion penalty function has an initial weight; (iii) iteratively computing one or more torsion parameters, wherein the computation of each torsion parameter of the one or more torsion parameters comprises: (a) performing a torsion-restricted numerical optimization to generate a set of candidate torsion-restricted free parameters, and (b) computing the torsion parameter based on the generated set of candidate torsion-restricted free parameters; and (iv) selecting the generated set of candidate torsion-restricted free parameters whose corresponding computed torsion parameter is less than a predetermined threshold value for torsion as the set of torsion-restricted free parameters; wherein a first torsion-restricted numerical optimization performed is based on (a) the obtained set of preliminary non-planar free parameters, (b) the obtained total objective function; and (c) a predetermined numerical optimization algorithm; and wherein each subsequent torsion-restricted numerical optimization is based on (a) a revised total objective function having at least an increased weight of the torsion penalty function relative to the initial weight of the torsion penalty function in the total objective function; (b) the set of candidate torsion-restricted parameters generated from the immediately preceding subsequent torsion-restricted numerical optimization; and (c) the predetermined numerical optimization algorithm.

In some embodiments, the stellarator includes between about 3 and about 100 planar encircling coils. In some embodiments, the stellarator comprises at least four planar encircling coils. In some embodiments, the plurality of planar encircling coils is comprised of one or more superconducting materials. In some embodiments, the plurality of planar encircling coils does not interlock with each other. In some embodiments, the stellarator comprises at least 4 field shaping units. In some embodiments, wherein the surface of the one or more structural mounting elements faces the void. In some embodiments, each of the one or more field shaping units comprises one structural mounting element. In some embodiments, the one structural mounting element is wedge shaped. In some embodiments, each of the one or more field shaping units comprises two or more structural mounting elements. In some embodiments, the one or more planar shaping coils do not interlock with each other. In some embodiments, a shape of each planar shaping coil of the one or more planar shaping coils is substantially rectangular, substantially rectangular with rounded corners, or substantially circular. In some embodiments, each of the one or more field shaping units comprises between about 5 and about 100 shaping coils. In some embodiments, each of the one or more field shaping units comprises between about 5 and about 50 shaping coils. In some embodiments, the one or more shaping coils are comprised of a superconducting material. In some embodiments, the stellarator further comprises one or more controllers. In some embodiments, the stellarator further comprises one or more control coils and/or one or more saddle coils. In some embodiments, the one or more control coils and/or the one or more saddles coils are communicatively coupled to a controller. In some embodiments, each of the one or more shaping coils do not individually encircle the plasma.

A third aspect of the present disclosure is a stellarator comprising: (a) a field-shaping coil system including one or more field shaping units which define a void adapted to confine a plasma, wherein each field shaping unit comprises: (i) one or more structural mounting elements; and (ii) one or more shaping coils disposed on a surface of the one or more structural mounting elements; and (b) a plurality of encircling coils which encircle the plasma and the field-shaping coil system; wherein the one or more shaping coils and the plurality of encircling coils are comprised of one or more superconducting materials; and wherein each encircling coil of the plurality of encircling coils do not interlock with each other; wherein the plurality of planar encircling coils are described by a set of torsion-restricted free parameters, wherein the set of torsion-restricted free parameters are generated by (i) obtaining a set of preliminary non-planar free parameters, where the set of preliminary non-planar free parameters describe one or more non-planar coils; (ii) obtaining a total objective function, wherein the total objective function is derived from at least two penalty functions, wherein one of the at least two penalty functions is a torsion penalty function, and wherein the torsion penalty function has an initial weight; (iii) iteratively computing one or more torsion parameters, wherein the computation of each torsion parameter of the one or more torsion parameters comprises: (a) performing a torsion-restricted numerical optimization to generate a set of candidate torsion-restricted free parameters, and (b) computing the torsion parameter based on the generated set of candidate torsion-restricted free parameters; and (iv) selecting the generated set of candidate torsion-restricted free parameters whose corresponding computed torsion parameter is less than a predetermined threshold value for torsion as the set of torsion-restricted free parameters; wherein a first torsion-restricted numerical optimization performed is based on (a) the obtained set of preliminary non-planar free parameters, (b) the obtained total objective function; and (c) a predetermined numerical optimization algorithm; and wherein each subsequent torsion-restricted numerical optimization is based on (a) a revised total objective function having at least an increased weight of the torsion penalty function relative to the initial weight of the torsion penalty function in the total objective function; (b) the set of candidate torsion-restricted parameters generated from the immediately preceding subsequent torsion-restricted numerical optimization; and (c) the predetermined numerical optimization algorithm.

In some embodiments, a shape of each of the one or more shaping coils is substantially rectangular, substantially rectangular with rounded corners, or substantially circular. In some embodiments, each of the one or more field shaping units comprises between about 5 and about 100 shaping coils. In some embodiments, each of the one or more field shaping units comprises between about 5 and about 50 shaping coils. In some embodiments, the one or more planar shaping coils do not interlock with each other. In some embodiments, each of the one or more field shaping units comprises one structural mounting element. In some embodiments, the one structural mounting element is wedge shaped. In some embodiments, each of the one or more field shaping units comprises two or more structural mounting elements. In some embodiments, each encircling coil of the plurality of encircling coils encircle the plasma confined within the void. In some embodiments, the stellarator includes between about 3 and about 100 encircling coils. In some embodiments, the stellarator comprises at least four encircling coils. In some embodiments, the plurality of encircling coils is comprised of one or more superconducting materials. In some embodiments, the of planar encircling coils do not interlock with each other.

A fourth aspect of the present disclosure is a stellarator comprising: (a) a void adapted to confine a plasma having a plasma axis; (b) a plurality of planar shaping coils, wherein an array comprising the plurality of planar shaping coils encircles the plasma axis, but where any individual planar shaping coil of the plurality of planar shaping coils does not encircle the plasma axis; and (c) a plurality of planar encircling coils, wherein each individual planar encircling coil of the plurality of encircling coils encircles the plasma axis; and wherein each planar encircling coil of the plurality of planar encircling coils do not interlock with each other; wherein the plurality of planar encircling coils are described by a set of torsion-restricted free parameters, wherein the set of torsion-restricted free parameters are generated by (i) obtaining a set of preliminary non-planar free parameters, where the set of preliminary non-planar free parameters describe one or more non-planar coils; (ii) obtaining a total objective function, wherein the total objective function is derived from at least two penalty functions, wherein one of the at least two penalty functions is a torsion penalty function, and wherein the torsion penalty function has an initial weight; (iii) iteratively computing one or more torsion parameters, wherein the computation of each torsion parameter of the one or more torsion parameters comprises: (a) performing a torsion-restricted numerical optimization to generate a set of candidate torsion-restricted free parameters, and (b) computing the torsion parameter based on the generated set of candidate torsion-restricted free parameters; and (iv) selecting the generated set of candidate torsion-restricted free parameters whose corresponding computed torsion parameter is less than a predetermined threshold value for torsion as the set of torsion-restricted free parameters; wherein a first torsion-restricted numerical optimization performed is based on (a) the obtained set of preliminary non-planar free parameters, (b) the obtained total objective function; and (c) a predetermined numerical optimization algorithm; and wherein each subsequent torsion-restricted numerical optimization is based on (a) a revised total objective function having at least an increased weight of the torsion penalty function relative to the initial weight of the torsion penalty function in the total objective function; (b) the set of candidate torsion-restricted parameters generated from the immediately preceding subsequent torsion-restricted numerical optimization; and (c) the predetermined numerical optimization algorithm.

In some embodiments, the plurality of planar shaping coils does not interlock one another. In some embodiments, the plurality of planar shaping coils does not interlock any one of the plurality of encircling coils. In some embodiments, plurality of planar encircling coils does not interlock one another. In some embodiments, the plurality of planar encircling coils does not interlock any one of the plurality of planar shaping coils. In some embodiments, the plurality of shaping coils is comprised of one or more superconducting materials. In some embodiments, the plurality of encircling coils is comprised of one or more superconducting materials. In some embodiments, the plurality of encircling coils and the plurality of planar shaping coils are both comprised of one or more superconducting materials. In some embodiments, a shape of each planar shaping coil of the one or more planar shaping coils is substantially rectangular, substantially rectangular with rounded corners, or substantially circular. In some embodiments, the stellarator comprises between about 10 and about 10,000 shaping coils. In some embodiments, the stellarator comprises between about 100 and about 2,000 shaping coils. In some embodiments, the stellarator includes between about 3 and about 100 planar encircling coils. In some embodiments, the stellarator comprises at least four planar encircling coils.

A fifth aspect of the present disclosure is stellarator comprising: (a) a void adapted to confine a plasma, wherein the void comprises at least two faces; (b) at least two planar shaping coils, wherein a first of the at least two planar shaping coils is proximal to a first of the at least two faces but does not encircle the void, and wherein a second of the at least two planar shaping coils is proximal to a second of the at least two faces but does not encircle the void; and (c) a plurality of planar encircling coils, wherein each individual planar encircling coil of the plurality of encircling coils encircles the plasma axis; wherein the plurality of planar encircling coils are described by a set of torsion-restricted free parameters, wherein the set of torsion-restricted free parameters are generated by (i) obtaining a set of preliminary non-planar free parameters, where the set of preliminary non-planar free parameters describe one or more non-planar coils; (ii) obtaining a total objective function, wherein the total objective function is derived from at least two penalty functions, wherein one of the at least two penalty functions is a torsion penalty function, and wherein the torsion penalty function has an initial weight; (iii) iteratively computing one or more torsion parameters, wherein the computation of each torsion parameter of the one or more torsion parameters comprises: (a) performing a torsion-restricted numerical optimization to generate a set of candidate torsion-restricted free parameters, and (b) computing the torsion parameter based on the generated set of candidate torsion-restricted free parameters; and (iv) selecting the generated set of candidate torsion-restricted free parameters whose corresponding computed torsion parameter is less than a predetermined threshold value for torsion as the set of torsion-restricted free parameters; wherein a first torsion-restricted numerical optimization performed is based on (a) the obtained set of preliminary non-planar free parameters, (b) the obtained total objective function; and (c) a predetermined numerical optimization algorithm; and wherein each subsequent torsion-restricted numerical optimization is based on (a) a revised total objective function having at least an increased weight of the torsion penalty function relative to the initial weight of the torsion penalty function in the total objective function; (b) the set of candidate torsion-restricted parameters generated from the immediately preceding subsequent torsion-restricted numerical optimization; and (c) the predetermined numerical optimization algorithm.

In some embodiments, the at least two faces are on opposite sides of the confined plasma. In some embodiments, the at least two planar shaping coils do not interlock one another. In some embodiments, the at least two planar shaping coils do not interlock any one of the plurality of encircling coils. In some embodiments, plurality of planar encircling coils does not interlock one another. In some embodiments, the plurality of planar encircling coils does not interlock any one of the at least two planar shaping coils. In some embodiments, the at least two planar shaping coils are comprised of one or more superconducting materials. In some embodiments, the plurality of encircling coils is comprised of one or more superconducting materials. In some embodiments, the plurality of encircling coils and the at least two planar shaping coils are both comprised of one or more superconducting materials.

A sixth aspect of the present disclosure is a stellarator comprising: (a) a plurality of structural supports; (b) one or more field shaping units operably connected to the plurality of structural supports, each field shaping unit comprising one or more planar, surface-mounted shaping coils; and (c) a plurality of planar encircling coils; wherein the plurality of structural supports, the one or more field shaping units, and the plurality of encircling coils collectively define a void adapted for confining plasma therein; wherein the plurality of planar encircling coils are described by a set of torsion-restricted free parameters, wherein the set of torsion-restricted free parameters are generated by (i) obtaining a set of preliminary non-planar free parameters, where the set of preliminary non-planar free parameters describe one or more non-planar coils; (ii) obtaining a total objective function, wherein the total objective function is derived from at least two penalty functions, wherein one of the at least two penalty functions is a torsion penalty function, and wherein the torsion penalty function has an initial weight; (iii) iteratively computing one or more torsion parameters, wherein the computation of each torsion parameter of the one or more torsion parameters comprises: (a) performing a torsion-restricted numerical optimization to generate a set of candidate torsion-restricted free parameters, and (b) computing the torsion parameter based on the generated set of candidate torsion-restricted free parameters; and (iv) selecting the generated set of candidate torsion-restricted free parameters whose corresponding computed torsion parameter is less than a predetermined threshold value for torsion as the set of torsion-restricted free parameters; wherein a first torsion-restricted numerical optimization performed is based on (a) the obtained set of preliminary non-planar free parameters, (b) the obtained total objective function; and (c) a predetermined numerical optimization algorithm; and wherein each subsequent torsion-restricted numerical optimization is based on (a) a revised total objective function having at least an increased weight of the torsion penalty function relative to the initial weight of the torsion penalty function in the total objective function; (b) the set of candidate torsion-restricted parameters generated from the immediately preceding subsequent torsion-restricted numerical optimization; and (c) the predetermined numerical optimization algorithm.

A seventh aspect of the present disclosure is a method of designing a stellarator comprising: (a) obtaining a field-shaping coil system including one or more field shaping units which define a void adapted to magnetically confine a plasma, wherein each field shaping unit comprises: (i) one or more structural mounting elements; and (ii) one or more planar shaping coils disposed on a surface of the one or more structural mounting elements, wherein the one or more planar shaping coils do not interlock with each other, and where each of the one or more shaping coils do not individually encircle the plasma; and (b) obtaining a plurality of planar encircling coils which encircle the field-shaping coil system, and wherein each planar encircling coil of the plurality of planar encircling coils do not interlock with each other; wherein the plurality of planar encircling coils are described by a set of torsion-restricted free parameters, wherein the set of torsion-restricted free parameters are generated by (i) obtaining a set of preliminary non-planar free parameters, where the set of preliminary non-planar free parameters describe one or more non-planar coils; (ii) obtaining a total objective function, wherein the total objective function is derived from at least two penalty functions, wherein one of the at least two penalty functions is a torsion penalty function, and wherein the torsion penalty function has an initial weight; (iii) iteratively computing one or more torsion parameters, wherein the computation of each torsion parameter of the one or more torsion parameters comprises: (a) performing a torsion-restricted numerical optimization to generate a set of candidate torsion-restricted free parameters, and (b) computing the torsion parameter based on the generated set of candidate torsion-restricted free parameters; and (iv) selecting the generated set of candidate torsion-restricted free parameters whose corresponding computed torsion parameter is less than a predetermined threshold value for torsion as the set of torsion-restricted free parameters; wherein a first torsion-restricted numerical optimization performed is based on (a) the obtained set of preliminary non-planar free parameters, (b) the obtained total objective function; and (c) a predetermined numerical optimization algorithm; and wherein each subsequent torsion-restricted numerical optimization is based on (a) a revised total objective function having at least an increased weight of the torsion penalty function relative to the initial weight of the torsion penalty function in the total objective function; (b) the set of candidate torsion-restricted parameters generated from the immediately preceding subsequent torsion-restricted numerical optimization; and (c) the predetermined numerical optimization algorithm.

An eighth aspect of the present disclosure is a method of generating a set of torsion-restricted free parameters which describe a design of one or more electromagnetic coils that are substantially planar, comprising: (a) obtaining a set of preliminary non-planar free parameters, where the set of preliminary non-planar free parameters describe one or more non-planar coils; (b) obtaining a total objective function, wherein the total objective function is derived from at least two penalty functions, wherein one of the at least two penalty functions is a torsion penalty function, and wherein the torsion penalty function has one or more initial parameters; (c) iteratively computing one or more torsion parameters, wherein the computation of each torsion parameter of the one or more torsion parameters comprises: (i) performing a torsion-restricted numerical optimization to generate a set of candidate torsion-restricted free parameters, and (ii) computing the torsion parameter based on the generated set of candidate torsion-restricted free parameters; and (d) selecting the generated set of candidate torsion-restricted free parameters whose corresponding computed torsion parameter is less than a predetermined threshold value for torsion as the set of torsion-restricted free parameters; wherein a first torsion-restricted numerical optimization performed is based on (i) the obtained set of preliminary non-planar free parameters, (ii) the obtained total objective function; and (iii) a predetermined numerical optimization algorithm; and wherein each subsequent torsion-restricted numerical optimization is based on (i) a revised total objective function having one or more altered parameters relative to the initial one or more parameters of the torsion penalty function in the total objective function; (ii) the set of candidate torsion-restricted parameters generated from the immediately preceding subsequent torsion-restricted numerical optimization; and (iii) the predetermined numerical optimization algorithm.

In some embodiments, the initial parameters for the torsion penalty function are target torsion τ₀=0.4/m and an exponent p=2.

In some embodiments, the total objective function is derived from at least three penalty functions.

In some embodiments, the at least two penalty functions each correspond to a different quantity to penalize. In some embodiments, a second of the at least two penalty functions correspond to a magnetic field error quantity to penalize. In some embodiments, the different quantities to penalize are selected from the group consisting of torsion, magnetic field error, coil-to-plasma distance, coil curvature, and coil-to-coil spacing.

In some embodiments, the set of preliminary non-planar free parameters are derived by performing a preliminary non-planar numerical optimization based on a set of preliminary planar free parameters and a total objective function for the preliminary non-planar numerical optimization. In some embodiments, the total objective function for the preliminary non-planar numerical optimization is derived from one or more penalty functions for the preliminary non-planar numerical optimization.

In some embodiments, the set of preliminary planar free parameters are derived by performing a preliminary planar numerical optimization based on a set initial planar free parameters and a total objective function for the preliminary planar numerical optimization. In some embodiments, the total objective function for the preliminary planar numerical optimization is derived from one or more penalty functions for the preliminary planar numerical optimization.

In some embodiments, the set of initial planar free parameters derived by: (i) obtaining an initial planar coil design; and (ii) choosing a parametrization which can only describe planar coils; and (iii) parametrizing the initial planar coil design with the chosen parametrization. In some embodiments, the parameterization chosen for the preliminary planar optimization is a Fourier representation that uses mode numbers 0 and 1. In some embodiments, the initial planar design describes a set of rotationally symmetric, circular coils. In some embodiments, set of initial planar design describes a set of coils which are placed and rotated rotationally symmetrically around a common axis. In some embodiments, the initial planar coil design includes between about 2 and about 100 coils. In some embodiments, the one or more coils of the initial planar coil design have an initial radius ranging from between about 1 cm to about 500 cm.

In some embodiments, the predetermined numerical optimization is selected from a Quasi-Newton algorithm, a Levenberg-Marquardt algorithm, an Interior Point method, an Ellipsoid method, a Broyden-Fletcher-Goldfarb-Shanno algorithm, a Conjugate Gradient method, and a Gradient Descent algorithm. In some embodiments, the numerical optimization is a variation of one of these algorithms, such as L-BFGS-B, which is a limited-memory version of the Broyden-Fletcher-Goldfarb-Shanno algorithm, with bounds on the free parameters.

In some embodiments, the predetermined threshold value for torsion is 0.1/m. In some embodiments, the predetermined threshold value for torsion is 0.05/m. In some embodiments, the predetermined threshold value for torsion is 0.01/m. In some embodiments, the predetermined threshold value for torsion is 0.05/m. In some embodiments, the predetermined threshold value for torsion is 0.001/m.

In some embodiments, the computing one or more torsion parameters is performed at least twice. In some embodiments, the computing one or more torsion parameters is performed at least three times. In some embodiments, the computing one or more torsion parameters is performed at least four times.

In some embodiments, the method further comprises designing one or more substantially planar coils for the stellarator based on the set of torsion-restricted free parameters.

In some embodiments, the method further comprises computing a set of revised torsion-restricted free parameters describing one or more planar coils. In some embodiments, the computing of the set of revised torsion-restricted free parameters comprises (i) deriving a mean filament of a coil design described by the set of torsion-restricted free parameters; (ii) identifying a mean plane of the mean filament; (iii) projecting the mean filament onto the mean plane; and (iv) computing the set revised torsion-restricted free parameters which describe the projected mean filament. In some embodiments, the method further comprises designing one or more planar coils for the stellarator based on the revised set of torsion-restricted free parameters.

A ninth aspect of the present disclosure is a stellarator comprising: (a) a field-shaping coil system including one or more field shaping units which define a void adapted to confine a plasma, wherein each field shaping unit comprises: (i) one or more structural mounting elements; and (ii) one or more planar shaping coils disposed on a surface of the one or more structural mounting elements, wherein the one or more planar shaping coils do not interlock with each other, and where each of the one or more shaping coils do not individually encircle the plasma; and (b) a plurality of planar encircling coils which encircle and interlock the field-shaping coil system, and wherein each planar encircling coil of the plurality of planar encircling coils do not interlock with each other; wherein the plurality of planar encircling coils are described by a set of torsion-restricted free parameters, wherein the set of torsion-restricted free parameters are generated by (i) obtaining a set of preliminary non-planar free parameters, where the set of preliminary non-planar free parameters describe one or more non-planar coils; (ii) obtaining a total objective function, wherein the total objective function is derived from at least two penalty functions, wherein one of the at least two penalty functions is a torsion penalty function, and wherein the torsion penalty function has one or more initial parameters; (iii) iteratively computing one or more torsion parameters, wherein the computation of each torsion parameter of the one or more torsion parameters comprises: (a) performing a torsion-restricted numerical optimization to generate a set of candidate torsion-restricted free parameters, and (b) computing the torsion parameter based on the generated set of candidate torsion-restricted free parameters; and (iv) selecting the generated set of candidate torsion-restricted free parameters whose corresponding computed torsion parameter is less than a predetermined threshold value for torsion as the set of torsion-restricted free parameters; wherein a first torsion-restricted numerical optimization performed is based on (a) the obtained set of preliminary non-planar free parameters, (b) the obtained total objective function; and (c) a predetermined numerical optimization algorithm; and wherein each subsequent torsion-restricted numerical optimization is based on (a) a revised total objective function having one or more altered parameters relative to the initial one or more parameters of the torsion penalty function in the total objective function; (b) the set of candidate torsion-restricted parameters generated from the immediately preceding subsequent torsion-restricted numerical optimization; and (c) the predetermined numerical optimization algorithm.

A tenth aspect of the present disclosure is a method of generating a set of torsion-restricted free parameters which describe a design of one or more electromagnetic coils that are substantially planar, comprising: obtaining a field-shaping coil system comprising a plurality of planar shaping coils, wherein the field-shaping coil system is adapted to magnetically confine a plasma; generating the set of torsion-restricted free parameters which describe the design of the one or more electromagnetic coils that are substantially planar, where the one or more electromagnetic coils that are substantially planar encircle and interlock the field-shaping coil system, wherein the set of torsion-restricted free parameters are generated by: obtaining a set of preliminary non-planar free parameters, where the set of preliminary non-planar free parameters describe one or more non-planar coils; obtaining a total objective function, wherein the total objective function is derived from at least two penalty functions, wherein a first of the at least two penalty functions is a torsion penalty function, wherein the torsion penalty function has one or more initial parameters, and wherein a second of the at least two penalty functions is derived from one or more quantities to penalize, wherein the one or more quantities to penalize for the second of the at least two penalty functions are selected from the group consisting of a required current in the plurality of shaping coils, a required conductor length of the plurality of shaping coils, and a maximum magnetic field of the plurality of shaping coils; iteratively computing one or more torsion parameters, wherein the computation of each torsion parameter of the one or more torsion parameters comprises: (a) performing a torsion-restricted numerical optimization to generate a set of candidate torsion-restricted free parameters, and (b) computing the torsion parameter based on the generated set of torsion-restricted free parameters; and selecting the generated set of candidate torsion-restricted free parameters whose corresponding computed torsion parameter is less than a predetermined threshold value for torsion as the set of torsion-restricted free parameters; wherein a first torsion-restricted numerical optimization performed is based on (a) the obtained set of preliminary non-planar free parameters, (b) the obtained total objective function; and (c) a numerical optimization algorithm; and wherein each subsequent torsion-restricted numerical optimization is based on (a) a revised total objective function having one or more altered parameters relative to the initial one or more parameters of the torsion penalty function in the total objective function; (b) the set of candidate torsion-restricted parameters generated from the immediately preceding subsequent torsion-restricted numerical optimization; and (c) the predetermined numerical optimization algorithm.

In some embodiments, each shaping coil of the plurality of shaping coils is planar. In some embodiments, the field-shaping coil system comprises one or more field shaping units which define a void adapted to confine the plasma, wherein each field shaping unit comprises: (i) one or more structural mounting elements; and (ii) the plurality of shaping coils disposed on a surface of the one or more structural mounting elements, wherein the plurality of shaping coils do not interlock with each other, and where each shaping coil of the plurality of shaping coils do not individually encircle the plasma. In some embodiments, each of the one or more field shaping units comprises between about 5 and about 100 shaping coils. In some embodiments, wherein the plurality of shaping coils is comprised of a superconducting material.

### BRIEF DESCRIPTION OF THE FIGURES

For a general understanding of the features of the disclosure, reference is made to the drawings. In the drawings, like reference numerals have been used throughout to identify identical elements.

FIG. 1 depicts the Wendelstein 7-X stellarator with a plasma and three sets of electromagnetic coils.

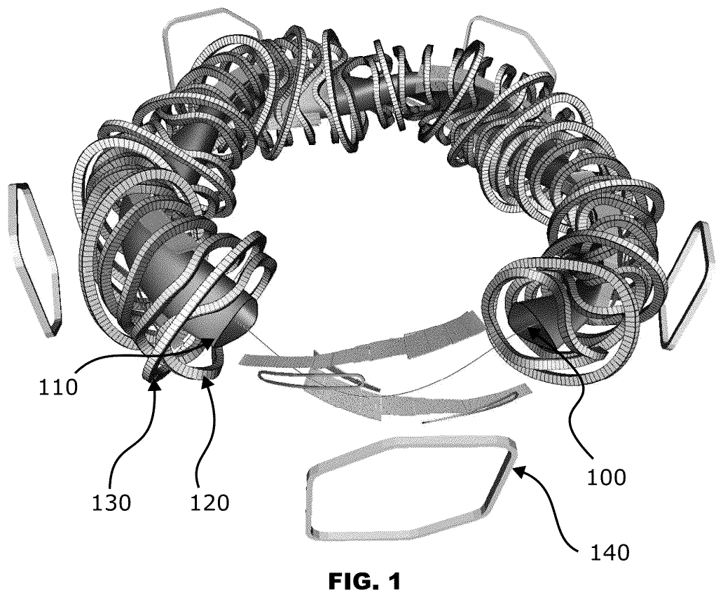

FIG. 2 depicts a stellarator design with a plasma and two sets of electromagnetic coils.

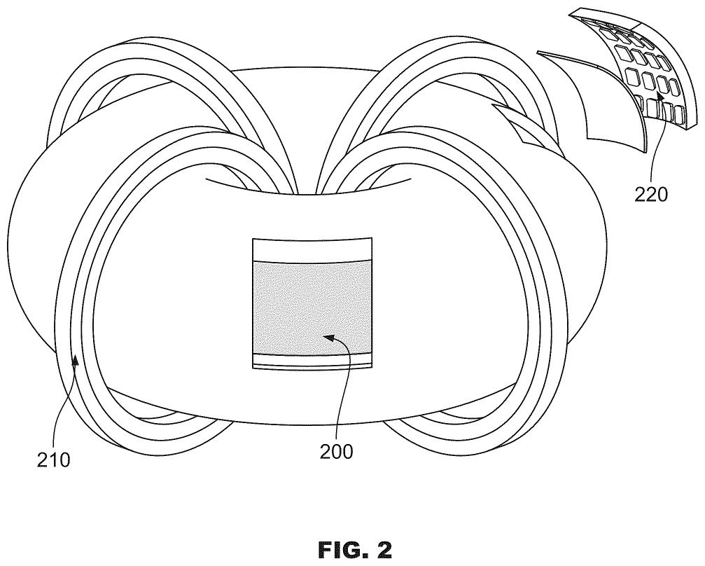

FIG. 3 provides a flowchart schematically representing the steps for performing one or more numerical optimizations in accordance with one embodiment with the present disclosure.

FIG. 4 depicts a system for performing a numerical optimization in accordance with one embodiment of the present disclosure.

FIG. 5A illustrates a method of computing a set of torsion restricted-free parameters which describe one or more substantially planar coils for use in a stellarator, in accordance with one embodiment of the present disclosure.

FIG. 5B illustrates a method of computing a set of torsion restricted-free parameters or a revised torsion-restricted free parameters which describe one or more substantially planar coils or one or more planar coils for use in a stellarator, respectively, in accordance with one embodiment of the present disclosure.

FIG. 5C illustrates a method of computing a set of torsion restricted-free parameters or a revised torsion-restricted free parameters which describe one or more substantially planar coils or one or more planar coils for use in a stellarator, respectively, in accordance with one embodiment of the present disclosure.

FIG. 5D illustrates a method of computing a set of torsion restricted-free parameters which describe one or more substantially planar coils for use in a stellarator, in accordance with one embodiment of the present disclosure.

FIG. 6 depicts a method of deriving a total objective function in accordance with one embodiment of the present disclosure.

FIG. 7 depicts a method of computing a set of preliminary non-planar free parameters in accordance with one embodiment of the present disclosure.

FIG. 8 depicts a method of computing a set of preliminary planar free parameters in accordance with one embodiment of the present disclosure.

FIG. 9 depicts a method of computing a set of initial planar free parameters in accordance with one embodiment of the present disclosure.

FIG. 10 illustrates several coil designs resulting from the sets of free parameters computed in accordance with the methods of the present disclosure. The upper-left portion of FIG. 10 shows a preliminary non-planar coil design obtained from a preliminary non-planar numerical optimization, whose preliminary planar coil design was obtained from a preliminary planar numerical optimization. The upper-right figure shows a first torsion-restricted coil design computed from the inverse parametrizing function of the chosen parametrization applied to a first set of torsion-restricted free parameters. The first set of torsion-restricted free parameters result from a first torsion-restricting numerical optimization with a first torsion penalty function given by Formula II, a target torsion of about 0.1/m and weight of about 10. The lower-left portion of FIG. 10 shows a second torsion-restricted coil design computed from the inverse parametrizing function of the chosen parametrization applied to a second set of torsion-restricted free parameters. The second set of torsion-restricted free parameters result from a second torsion-restricting numerical optimization with a target torsion of about 0.05/m and weight of about 100. The lower-right portion of FIG. 10 shows a third torsion-restricted coil design computed from the inverse parametrizing function of the chosen parametrization applied to a third set of torsion-restricted free parameters. The third set of torsion-restricted free parameters result from a third torsion-restricting numerical optimization with a target torsion of about 0.0/m and weight of about 10000. This coil design is substantially planar. In FIG. 10, each total objective function includes penalty functions describing quantities to penalize: magnetic error, coil-to-plasma distance, coil length, coil-to-coil distance, and torsion.

FIG. 11 illustrates an initial planar coil design which describes 12 circular coils that are placed vertically and rotated rotationally symmetrically about a common axis. The coil minor radius and center of each coil is identical for each of the coils. Upper figure: A view of the coils along the vertical axis with which the coil plane is aligned. Lower figure: A different view of the same coil set at an arbitrary viewing angle.

FIG. 12 illustrates a substantially planar coil design described by an accepted revised set of torsion-restricted free parameters. One quarter of the plasma and coil set is shown from the outside (left figure) and inside (right figure). Three unique coils are shown. The surface of the plasma is shaded to show the amplitude of the magnetic field, showing that magnetic field error is reasonable. These coils are the output of Example 5.

### DETAILED DESCRIPTION

### Definitions

It should also be understood that, unless clearly indicated to the contrary, in any methods claimed herein that include more than one step or act, the order of the steps or acts of the method is not necessarily limited to the order in which the steps or acts of the method are recited.

As used herein, the singular terms “a,” “an,” and “the” include plural referents unless context clearly indicates otherwise. Similarly, the word “or” is intended to include “and” unless the context clearly indicates otherwise. The term “includes” is defined inclusively, such that “includes A or B” means including A, B, or A and B.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of” or “exactly one of.” “Consisting essentially of,” when used in the claims, shall have its ordinary meaning as used in the field of patent law.

The terms “comprising,” “including,” “having,” and the like are used interchangeably and have the same meaning. Similarly, “comprises,” “includes,” “has,” and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a device having components a, b, and c” means that the device includes at least components a, b, and c. Similarly, the phrase: “a method involving steps a, b, and c” means that the method includes at least steps a, b, and c. Moreover, while the steps and processes may be outlined herein in a particular order, the skilled artisan will recognize that the ordering steps and processes may vary.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

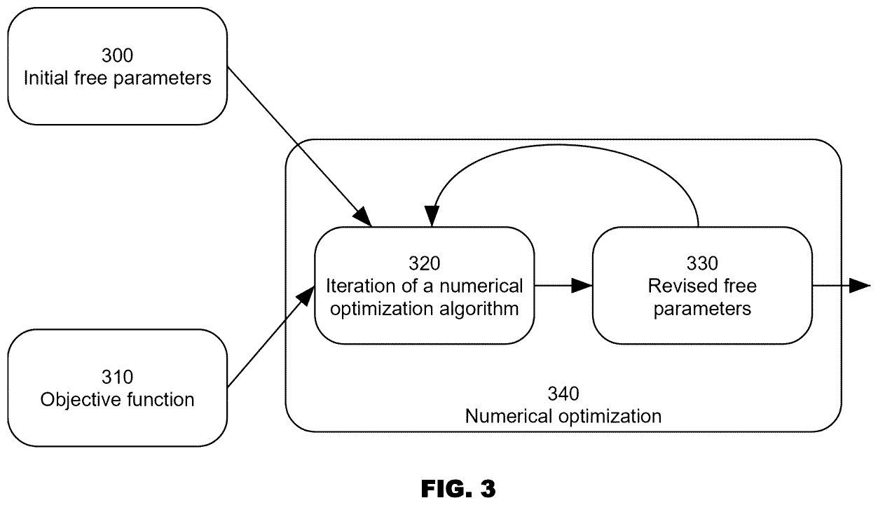

As used herein, the term “numerical optimization” refers to the use of any one of several algorithms which take in an initial set of free parameters and an objective function, and output a revised one or more free parameters which are nearer to a local optimum of the objective function. For instance, and with reference to FIG. 3, numerical optimization may refer to the repeated application (“iteration”) of any one of several algorithms 320 which take in an initial one or more free parameters 300 and an objective function 310, and output a revised one or more free parameters 330 which are nearer to a local optimum of the objective function. Non-limiting examples of algorithms which can be used are the Quasi-Newton algorithm, the Levenberg-Marquardt algorithm, the Interior Point method, the Ellipsoid method, a Broyden-Fletcher-Goldfarb-Shanno algorithm, the Conjugate Gradient method, the Gradient Descent algorithm, and the L-BFGS-B algorithm. The free parameters are also commonly called optimization variables or degrees of freedom. The initial one or more free parameters is also commonly called an initial guess. The revised one or more free parameters is also commonly called the updated free parameters or an optimized free parameters. The objective function is also commonly called a figure of merit, a penalty function, a cost function, or a reward function.

As used herein, a “penalty function” is an objective function which describes a quantity, such that the free parameters which extremize the objective function have a satisfactory value of that undesired quantity. For example, if it is desired that some curve stay close to the origin, the penalty function may be the line integral of the spherical radius of the curve.

As used herein, a “total objective function” is a combination of multiple penalty functions, such that the extremum of the total objective function is one or more parameters which trades off undesired quantities. An example of the combination of multiple penalty functions is their linear addition, with some coefficient or “weight” which determines the relative importance of each undesired quantity. If the combination of penalty functions is not by simple linear addition, “weight” instead describes the relative importance of that penalty function to determining the value of the total objective function.

As used herein, an “iteration” is a single application of a numerical optimization algorithm. In some embodiments, a numerical optimization consists of one or more iterations, such as two or more iterations, such as three or more iterations, such as four or more iterations, such as six or more iterations, such as eight or more iterations, such as ten or more iterations, etc. For instance, an initial guess of iteration 1 is an initial one or more free parameters. The output of iteration 1 is the first revised free parameters. The initial guess of iteration N+1 is the Nth revised free parameters. The output of iteration N+1 is the N+1th revised free parameters. The output of a numerical optimization is the output of the last iteration.

As used herein, coils that are “described” by free parameters refers to the output of the inverse parametrizing function of the chosen parametrization. For example, if the parametrization is a Fourier representation, then the free parameters include Fourier amplitudes of Fourier modes. A design of coils that are “described” by those free parameters is obtained by performing an inverse Fourier transform of those modes, yielding a mean filament. The coil may be further specified by a cross section and an electrical current, more free parameters.

As used herein, a curve that is described as “planar” is a curve in which all points lie within one plane. The curve has no helicity, and no torsion as defined using the Frenet-Serret formulae. In some embodiments, a coil design is considered “substantially planar” if its torsion is less than some small value. In some embodiments, the small value is 0.1/m. In other embodiments the small value is 0.01/m. In some embodiments, it is the maximum torsion that is compared. In some embodiments it is the average torsion that is compared.

As used herein, an electromagnetic coil that is described as “planar” is a coil whose electrical-current-carrying wires are collected around a mean filament, and whose mean filament is a planar curve as defined above.

As used herein, a curve which “encircles” a feature is one which interlocks or links the feature like the links of a chain.

As used herein, the phrases “planar encircling coil” or a “substantially planar encircling coil” refer to electromagnetic coils, such as for use in a stellarator, which encircle the plasma confined within the stellarator or within one or more components of the stellarator; and which is planar or substantially planar, respectively.

As used herein, “torsion” is a mathematical quantity of a curve defined using the Frenet-Serret formulae. It is believed that an important property of a coil is the torsion of its mean filament. Torsion describes how non-planar or twisty a curve is. For a mathematical definition of torsion, see the Frenet-Serret formulae. Torsion is a function of distance along the curve and is a measure of the out-of-plane behavior of the curve. Planar curves have zero torsion at all points. Non-planar curves have at least some points with finite torsion.

As used herein, a “parametrization” of an object is a method of specifying the properties of that object using one or more free parameters (numbers). One “parametrization” of a curve is to obtain the Cartesian X, Y, and Z coordinates of the points that make up the curve by performing an inverse Fourier transform on a list of Fourier amplitudes. The list of Fourier amplitudes is the list of free parameters of this parameterization. Another parametrization of a curve is to obtain the Cartesian X, Y, and Z coordinates of the points that make up the curve by using splines to interpolate between a list of spline knots. The list of spline knots is the list of free parameters of this parameterization. The parameterization of a coil may use one of these parametrizations of the mean filament of a coil, then use another set of parameters to describe the cross-section of the coil that is swept around this mean filament. For example, the cross section could be a rectangle described by a height dimension and a width dimension. In this case the free parameters that describe the mean filament, and the height and width of the cross section, together are the free parameters of this parametrization. The skilled artisan will appreciate that every parametrization entails a “parametrizing function,” which computes one or more free parameters from a description of the object to be parametrized; and an “inverse parametrizing function,” which computes a description of the object from one or more free parameters.

The present disclosure is directed to systems methods for generating a set of torsion-restricted free parameters which describe a substantially planar coil. In the systems and methods described herein, a penalty function is utilized to make an initially non-planar curve progressively more planar as a new way of optimizing a design of substantially planar coils for a stellarator. In this regard, the set of torsion-restricted free parameters is generated by utilizing a set of preliminary non-planar free parameters which describe one or more non-planar coils. Compared to other coil optimization methods which utilize a coil representation that is strictly planar, and which avoid the need for a torsion penalty function (but potentially reducing the solution space), it is believed that the systems and methods described herein can reach superior local minima by retaining a larger initial solution space by averting strictly planar curves.

### Overview

System for Generating a Set of Torsion-Restricted Free Parameters Describing Substantially Planar Coils

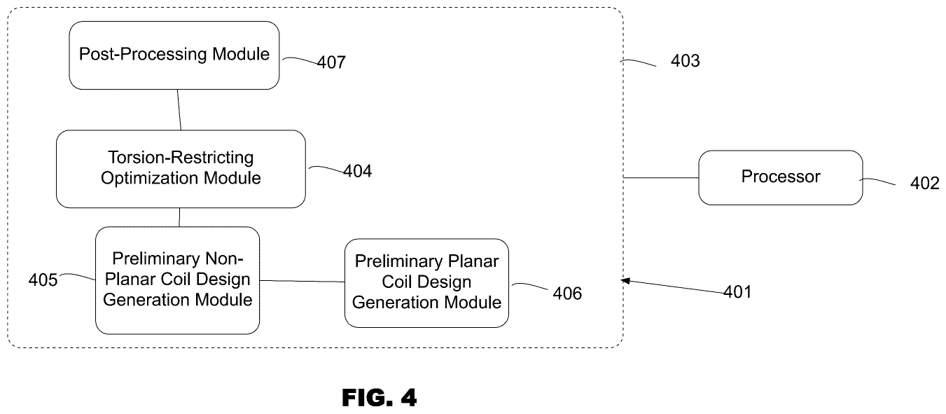

A system 401 for generating one or more substantially planar electromagnetic coils for use in a stellarator is illustrated in FIG. 4. In some embodiments, the system 401 includes one or more processors 402 and one or more memories 403 adapted to compute one or more free parameters using one or more of modules 404, 405, and 406, where the computed one or more free parameters are used to generate a design for one or more coils for use in a stellarator. In some embodiments, a torsion-restricted free parameter generation module 404 computes one or more torsion-restricted free parameters based at least on (i) one or more non-planar free parameters; and (ii) a derived total objective function. The output of the torsion-restricted free parameter generation module 404 is one or more torsion-restricted free parameters that meet a predefined threshold value for torsion, and which describe one or more substantially planar coils.

In some embodiments, the system 401 includes a preliminary non-planar free parameter generation module 405 which is used to generate one or more preliminary non-planar free parameters based on (i) one or more preliminary planar free parameters, and (ii) a total objective function for the preliminary non-planar numerical optimization. In some embodiments, the system 401 further includes a preliminary planar free parameter generation module 407 which is used to generate one or more preliminary planar free parameters based on (i) an obtained set of initial planar free parameters describing one or more planar coils; and (ii) a total objective function for the preliminary planar numerical optimization. In some embodiments, the system 401 further includes a post-processing module 407 used to further generate a set of revised torsion-restricted free parameters which describe one or more planar coils.

### Method of Generating a Set of Torsion-Restricted Free Parameters Describing Substantially Planar Coils

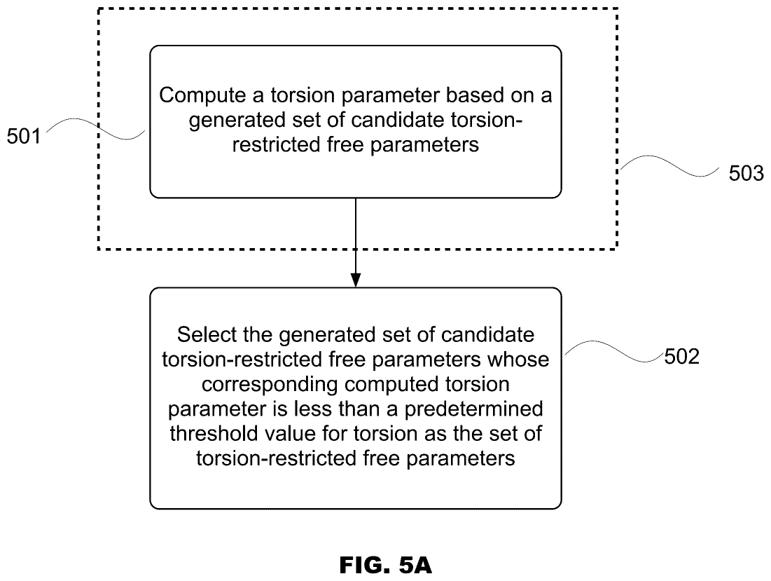

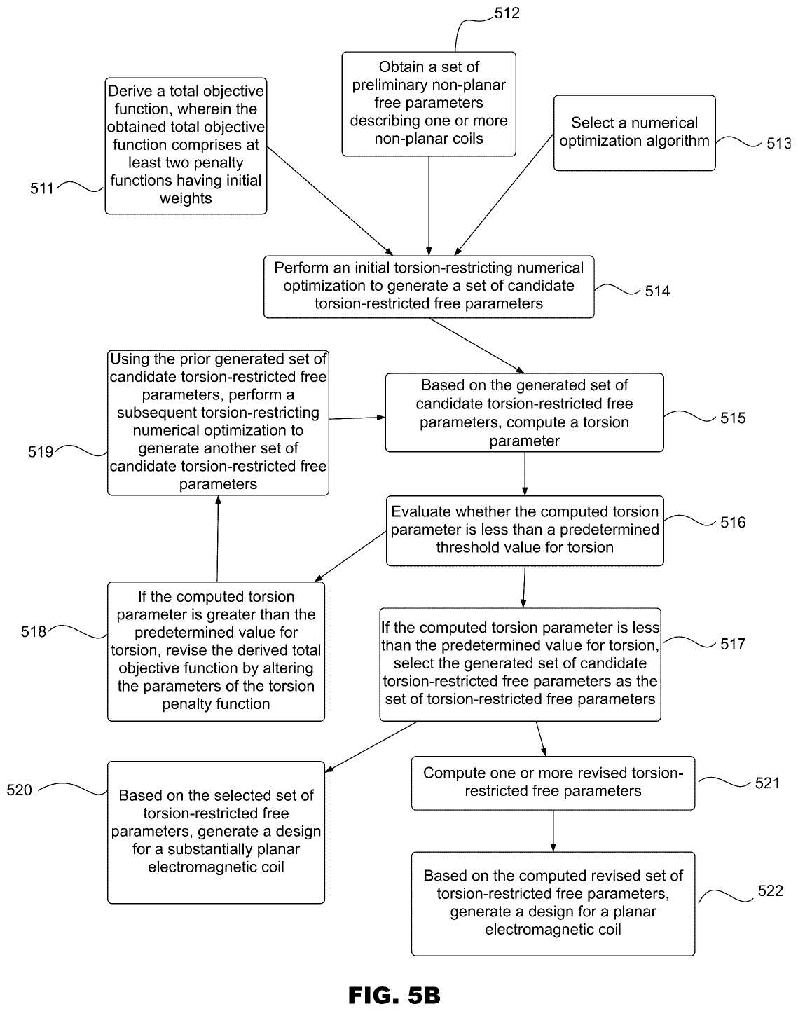

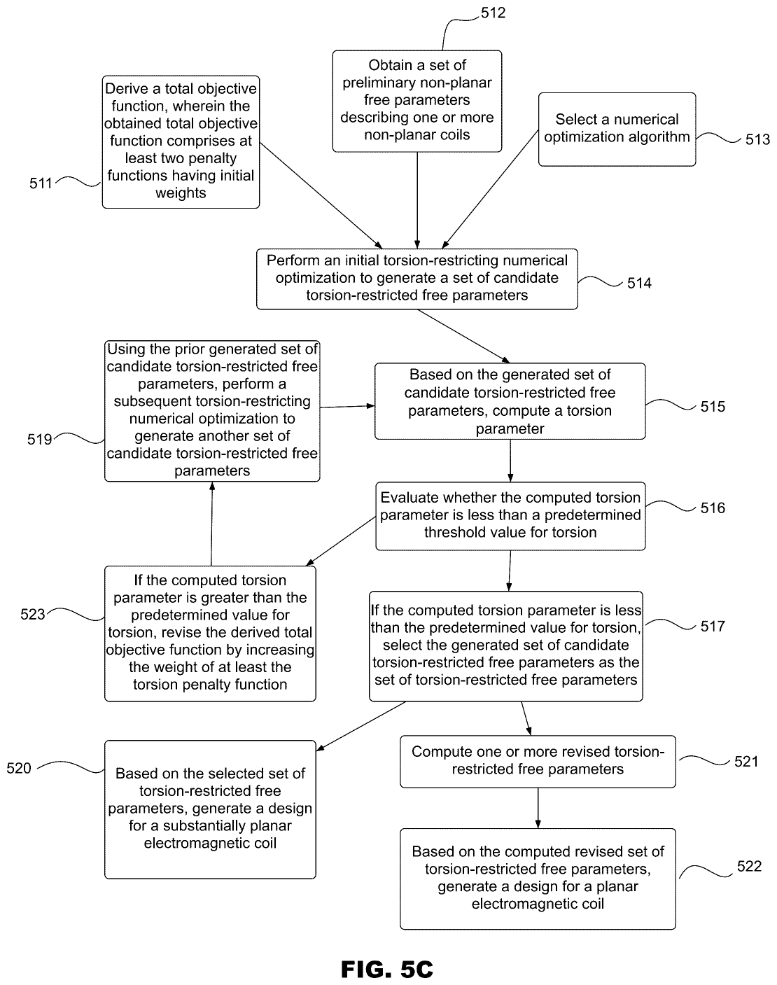

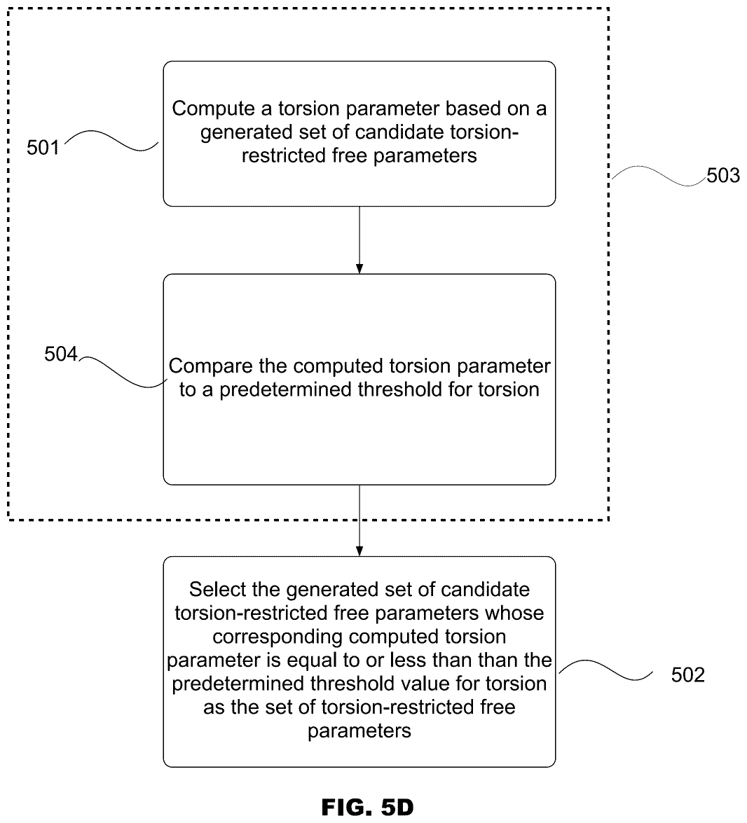

In some embodiments, the method of generating a set of torsion-restricted free parameters describing substantially planar coils comprises (i) iteratively computing torsion parameters, where each torsion parameter is computed from a generated set of candidate torsion-restricted free parameters (see steps 501 and 503 of FIG. 5A, where the dashed line of step 503 indicates that step 501 may be repeated one or more times); and (ii) selecting the generated set of candidate torsion-restricted free parameters whose corresponding computed torsion parameter is less than a predetermined threshold value for torsion (e.g., a predetermined threshold value for torsion of about 0.1/m) as the set of torsion-restricted free parameters (see step 502 of FIG. 5A).

With reference to FIG. 5D, in some embodiments, the method of generating a set of torsion-restricted free parameters describing substantially planar coils comprises (i) computing torsion parameters, where each torsion parameter is computed from a generated set of candidate torsion-restricted free parameters (step 501); (ii) comparing the computed torsion parameter to a predetermined threshold for torsion (step 504); (iii) optionally repeating steps 501 and 504; and (iv) selecting the generated set of candidate torsion-restricted free parameters whose corresponding computed torsion parameter is less than a predetermined threshold value for torsion (e.g., a predetermined threshold value for torsion of about 0.1/m) as the set of torsion-restricted free parameters (see step 502).

In some embodiments, the computation of the torsion parameter is computed more than once (step 503), and where each computation is based on a different set of candidate torsion-restricted free parameters, and where each different set of candidate torsion-restricted free parameters is derived using a numerical optimization utilizing a different total objective, such as where each total objective function differs in the weight of an incorporated torsion penalty function.

In those embodiments where the computation of the torsion parameter is performed more than once, a first set of candidate torsion restricted-free parameters is derived utilizing (i) an obtained set of preliminary non-planar free parameters which describe one or more non-planar coils, (ii) an obtained total objective function, where the total objective function is derived from at least two penalty functions, wherein one of the at least two penalty functions is a torsion penalty function, and wherein the torsion penalty function has an initial weight; and (iii) a numerical optimization algorithm (see, e.g., FIG. 5C). Alternatively, in those embodiments where the computation of the torsion parameter is performed more than once, a first set of candidate torsion restricted-free parameters is derived utilizing (i) an obtained set of preliminary non-planar free parameters which describe one or more non-planar coils, (ii) an obtained total objective function, where the total objective function is derived from at least two penalty functions, wherein one of the at least two penalty functions is a torsion penalty function, and wherein the torsion penalty function has an initial set of parameters; and (iii) a numerical optimization algorithm (see, e.g., FIG. 5B).

In those embodiments where the computation of the torsion parameter is performed more than once, each subsequent set of candidate torsion-restricted free parameters is derived utilizing (i) a revised total objective function having an increased weight of the torsion penalty function relative to the initial weight of the torsion penalty function in the total objective function; (ii) the set of candidate torsion-restricted parameters generated from the immediately preceding subsequent torsion-restricted numerical optimization; and the (iii) predetermined numerical optimization algorithm (see, e.g., FIG. 5C). Alternatively, in those embodiments where the computation of the torsion parameter is performed more than once, each subsequent set of candidate torsion-restricted free parameters is derived utilizing (i) a revised total objective function having an alerted set of parameters of the torsion penalty function relative to the initial parameters of the torsion penalty function in the total objective function; (ii) the set of candidate torsion-restricted parameters generated from the immediately preceding subsequent torsion-restricted numerical optimization; and the (iii) predetermined numerical optimization algorithm (see, e.g., FIG. 5B).

### Deriving a Total Objective Function

With reference to FIGS. 5B and 5C, a first step of the method includes deriving a total objective function (step 511). In some embodiments, the obtained total objective function is derived from two or more penalty functions, where one of the two or more penalty functions is a torsion penalty function.

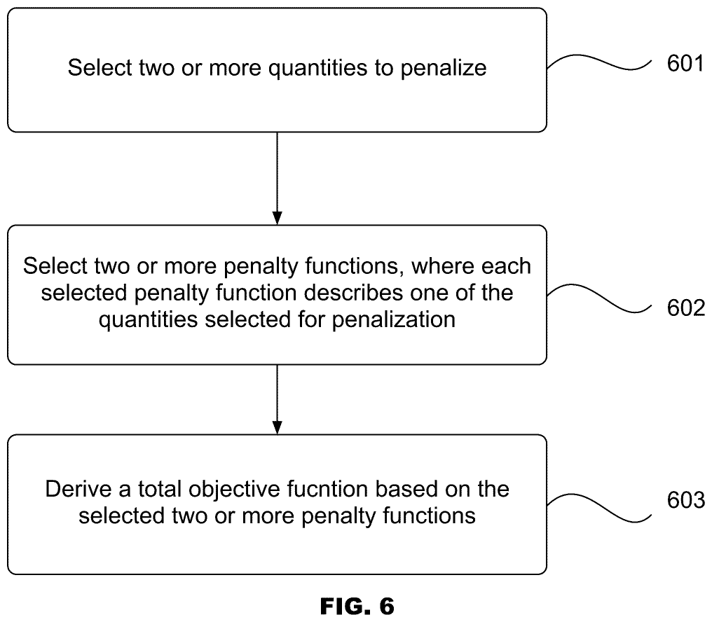

In some embodiments, and with reference to FIG. 6, a total objective function may be derived by (i) selecting two or more quantities to penalize, where one of the two quantities to penalize is torsion (step 601); (ii) selecting two or more penalty functions, where each of the selected penalty functions describe one of the quantities selected for penalization (step 602); and (iii) deriving the total objective function based on the selected two or more penalty functions (step 603).

In some embodiments, one of the two or more quantities to penalize is torsion; while another of the two or more quantities to penalize is selected from magnetic field error, coil-plasma distance, coil curvature (such as defined by the Frenet-Serret formulae), and coil-to-coil spacing. In some embodiments, the two or more quanties to penalize are torsion and magnetic field error. In some embodiments, three or more quantities to penalize are selected, wherein one of the three or more quantities to penalize is torsion, another of the three or more quantities to penalize is magnetic field error, and yet another of the three or more quantities to penalize is selected from coil-plasma distance, coil curvature (such as defined by the Frenet-Serret formulae), and coil-to-coil spacing.

In some embodiments, torsion is selected as the quantity to penalize such that the generated set of candidate torsion-restricted free parameters describe one or more coils whose torsion is small, eventually becoming substantially zero for the selected set of torsion-restricted free parameters.

In some embodiments, magnetic field error is selected as a quantity to penalize such that the selected set of torsion-restricted free parameters describe one or more coils which produce the desired magnetic field, or a large portion of the desired magnetic field (greater than about 50% of the desired magnetic field, greater than about 90% of the desired magnetic field, or greater than about 99% of the desired magnetic field). In some embodiments, the desired magnetic field error of the coils described by the selected set of torsion-restricted free parameters is about 1%, such as about 0.5%, or such as about 0.1%. In some embodiments, if the coils described by the selected set of torsion-restricted free parameters act in combination with one or more additional coil sets to produce the desired magnetic field, the desired magnetic field error ranges from about 10% to about 50%.

In some embodiments, the coil-plasma distance is selected as a quantity to penalize such that the selected set of torsion-restricted free parameters describe one or more coils having sufficient spacing between the coils and a plasma surface, and such that space is provided to accommodate other components of a stellarator (e.g., a first wall, a neutronic breeding blanket, a neutronic shield, and structural members). In some embodiments, a desired coil-plasma distance is greater than about 50 cm, such as greater than about 100 cm, such as greater than about 20 cm, such as greater than about 150 cm, etc.

In some embodiments, the coil curvature is chosen as a quantity to penalize such that the selected set of torsion-restricted free parameters describe one or more coils which are not too curved to manufacture easily. It is believed that a tight curvature of electromagnetic coils introduces difficulties in manufacturing and winding electrical wire, and introduces stress and magnetic field concentrations. In some embodiments, the desired curvature of a coil is less than about 10/m, such as less than about 5/m, such as less than about 2/m, such as less than about 1/m, such as less than about 0.5/m, such as less than about 0.2/m, such as less than about 0.1/m, etc.

In some embodiments, the coil-to-coil spacing is chosen as a quantity to penalize such that the selected set of torsion-restricted free parameters describe two or more coils which are sufficiently spaced apart from one another. In some embodiments, two or more coils must have some minimum space between them so that they do not physically interfere with each other, and so that the magnetic forces they exert on each other are not impractical. In some embodiments, the desired coil-to-coil spacing is greater than about 75 cm, such as greater than about 1 m, such as greater than about 2 m, etc.

As noted above, two or more penalty functions are selected, where each selected penalty function describes one of the quantities selected for penalization. For example, a first penalty function of the two or more penalty functions is selected which describes a first of the two quantities selected for penalization; and a second penalty function of the two or more penalty functions describes a second of the two quantities selected for penalization. In some embodiments, one of the two or more penalty functions include a torsion penalty function.

In general, the penalty function selected includes one or more of a power-law of the quantity to be penalized, a thresholding of that quantity to be penalized using the Heaviside step function, a hyperbolic cosine of the quantity to be penalized, a spatial integral (a line integral, surface integral) of the quantity to be penalized, a maximum of the quantity to be penalized, and average of the quantity to be penalized.

In some embodiments, the torsion penalty function is the length integral of a power law of a thresholded torsion value (see Formula II, herein). In some embodiments, the torsion-restricting numerical optimization (see step 514) uses a total objective function with a low weight (e.g., 0.001) multiplying the penalty function which describes torsion and a relatively large maximum torsion (e.g., 100/m). Consequently, the first torsion-restricting optimization produces a set of free parameters which describe a coil design with finite torsion.

In some embodiments, the one or more quantities to penalize and the corresponding one or more first penalty functions are selected from:

### Quantity: Coil-Coil Spacing

i. Example penalty function:

$$J = {\sum }_{i = 1}^{ncoils} {\sum }_{j = 1}^{i - 1} {d}_{i , j}$$

$$1. {d}_{i , j} = {\int }_{{C}_{i}} {\int }_{{C}_{j}} {max ( 0 , {d}_{min} - {‖ {r}_{i} - {r}_{j} ‖}_{2} )}^{2} {dl}_{j} {dl}_{i}$$

ii. Here, J is the penalty function, d_{i,j} is the distance of closest approach between the mean filaments of coils i and j. dₘᵢₙ is the target minimum value supplied by the operator. rᵢ, rⱼ are position vectors of coils i and j and the integrals are taken over the curves Cᵢ, Cⱼ, the mean filaments of coils i and j.
iii. In some embodiments, target values of d_{i,j} range from 1 mm to 5 m. In other embodiments, target values of d_{i,j} range from 1 mm to 3 m. In other embodiments, target values of d_{i,j} range from 1 cm to 1 m. In other embodiments, target values of d_{i,j} range from 10 cm to 1 m.

### Quantity: Plasma-Coil Spacing

Example penalty function:

$$J = {\sum }_{i = 1}^{ncoils} {d}_{i}$$

$$1. {d}_{i} = {\int }_{{C}_{i}} {\int }_{S} {max ( 0 , {d}_{min} - {‖ {r}_{i} - s ‖}_{2} )}^{2} {dl}_{i} ds$$

v. Here, J is the penalty function, dᵢ is the distance of closest approach of coil i to the plasma surface, s. rᵢ, s are the position vectors of coil i and the plasma surface, respectively. The integrals are taken over curve i and the plasma surface.
vi. In some embodiments, target values of dᵢ range from 1 mm to 10 m. In other embodiments, target values of dᵢ range from 1 cm to 5 m. In other embodiments, target values of dᵢ range from 1 cm to 3 m. In other embodiments, target value of dᵢ range from 10 cm to 1 m.

### Quantity: Coil Curvature

vii. Example penalty function: J=C∫_{curve}(H(κ*)κ*)^{p}dl
viii. Where J is the penalty function, κ is the curvature as defined using the Frenet-Serret formulae, κ*=|κ|−κ₀. Here, κ₀ and p (where p>1) are input parameters, C is an arbitrary multiplicative constant, and H(x) is the Heaviside step function. κ is the curvature at a given point along the curve.
ix. In some embodiments, target values of κ₀ range from −10 m⁻¹ to +10 m⁻¹. In other embodiments, target values of κ₀ range from −5 m⁻¹ to +5 m⁻¹. In other embodiments, target values of κ₀ range from −3 m⁻¹ to +3 m⁻¹.

### Quantity: Coil Torsion

i. Example penalty function:

$$J = C {\int }_{curve} {( H ( {τ}_{*} ) {τ}_{*} )}^{p} dl \qquad ( Formula II )$$

x. where τ is the torsion, τ*=|τ|−τ₀. Here, τ₀ and p (where p>1) are parameters of the penalty function, C is an arbitrary multiplicative constant, and H(x) is the Heaviside step function (where, τ₀, may be referred to as the target torsion; and p may be referred to as the exponent).
xi. Other embodiments use, for the penalty function which describes torsion, the hyperbolic cosine form of Equation 2.9 in [T. Kruger et al., J. Plasma Phys. (2021), vol. 87, 175870201], the disclosure of which is hereby incorporated by reference herein in its entirety.
xii. In some embodiments, target values of τ₀ range from 0.01 to 10/m.

### Quantity: Individual Coil Length

xiii. Example penalty function: J=∫_{curve}dl
xiv. J is the penalty function. This objective simply integrates along the curve to determine the total length.
xv. Individual coil length targets could be applied to some or all of the coils under consideration. For cases where individual coil lengths for multiple coils are considered, the target values for a given coil can be less than, equal to, or greater than the target values for any of the other coils.
xvi. In some embodiments, target values of J range from 1 m to 100 m. In other embodiments, target values of J range from 2 m to 50 m. In other embodiments, target values of J range from 4 m to 20 m. In other embodiments, target values of J range from 6 m to 15 m.

### Quantity: Total Coil Length

xvii. Example penalty function: J=Σᵢ∫_{curve} dlᵢ
xviii. J is the penalty function.
xix. This objective sums over the integral along each curve to target the total length of all coils.
xx. In some embodiments, target values of J range from 1 m to 10,000 m. In other embodiments, target values of J range from 10 m to 1,000 m. In other embodiments, target values of J range from 10 m to 500 m. In other embodiments, target values of J range from 10 m to 100 m. In other embodiments, target values of J range from 10 m to 50 m.

### Quantity: Magnetic Field Error

xxi. Example penalty function: J=∫_{S}(\vec{B}·\hat{n})² ds
xxii. where J is the penalty function, the surface integral is taken over the plasma surface S, B is the magnetic field, and î is the surface-normal vector of the plasma surface
xxiii. In some embodiments, target values of J are 0.5 T²m². In other embodiments, target values of J are 0.15 T²m². In other embodiments, target values of J are 0.05 T²m². In other embodiments, target values of J are 0.015 T²m².

In some embodiments, the one or more penalty functions include one or more measures of feasibility for one or more additional coils included within a stellarator. For instance, and in some embodiments, the selected set of torsion-restricted free parameters describe one or more coils which may operate alongside one or more additional sets of electromagnetic coils, such as non-planar coils (120) or planar non-encircling coils (140) or planar field-shaping coils (220). In some embodiments, the measures of feasibility comprises a total amount of conductor or maximum local magnetic field required in the one or more additional coils to reduce the magnetic field error to substantially zero (e.g. 0.01 Tesla).

Following the selection of the two or more penalty functions, a total objective function is derived (step 511) by combining the two or more selected penalty functions. In some embodiments, the total objective function is the linear sum of the penalty functions with different weights as defined in Formula I:

$${f}_{total} ( \vec{x} ) = {\sum }_{i} {w}_{i} {f}_{i} \cdot ( \vec{x} ) , \qquad ( Formula I )$$

where the functions fᵢ are individual penalty functions which describe an undesired property of a design of one or more coils, and where the weights wᵢ control the importance of fᵢ relative to other penalty functions comprising the total objective function fₜₒₜₐₗ. For instance, if a penalty function which describes one quantity, such as magnetic field error, is combined with a penalty function which describes another quantity, such as coil curvature, the resultant optimum of this total objective function is a tradeoff between the two quantities.

In some embodiments, each penalty function (including each penalty function combined into the total objective function) has a weight wᵢ. In these embodiments, the selection of weights determines the relative importance of that penalty function in generating each of the sets of candidate torsion-restricted free parameters, described below. For example, if the weight of a penalty function describing magnetic field error is 1000, and the weight of a penalty function describing coil curvature is 1, a generated set of candidate torsion-restricted free paramaters will describe one or more coils which faithfully reproduces the desired magnetic field but has undesirable, high curvature. The weights and penalty functions can be different for different steps in the method of the present disclosure (see, e.g., steps 514 and 519, where in step 514 initial weights of the two or more penalty functions are selected and used to derive the total objective function, whereas in step 519 the weights of the two or more penalty functions may be varied in comparison to the initial penalty function weights).

### Selection of a Numerical Optimization Algorithm

With reference again to FIG. 5B, following the obtaining of a total objective function, a numerical optimization algorithm is selected (step 512). In some embodiments, the numerical optimization algorithm is a Quasi-Newton algorithm. In other embodiments, the numerical optimization algorithm is a Levenberg-Marquardt algorithm. In other embodiments, the numerical optimization algorithm is an Interior Point method. In other embodiments, the numerical optimization algorithm is an Ellipsoid method. In other embodiments, the numerical optimization algorithm is a Broyden-Fletcher-Goldfarb-Shanno algorithm. In other embodiments, the numerical optimization algorithm is a Conjugate Gradient method. In other embodiments, the numerical optimization algorithm a Gradient Descent algorithm. In other embodiments, the numerical optimization algorithm is L-BFGS-B, which is a variation of the Broyden-Fletcher-Goldfar-Shanno algorithm.

In some embodiments, the selection of the numerical optimization algorithm (step 512) is informed based on the derived total objective function (see step 511) and a parametrization. For example, some algorithms are known to be superior when there are a large number of free parameters, such as stochastic gradient descent. By way of another example, some algorithms are known to be superior when the total objective function is smooth, such as the Quasi-Newton method. By way of yet another example, some algorithms are known to be superior when the total objective function has regions of high-order parametric dependence, such as the Levenberg-Marquardt algorithm. By way of yet a further example, some algorithms are known to be superior when the total objective function is convex, like the Interior Point method.

### Obtaining a Set of Preliminary Non-Planar Free Parameters

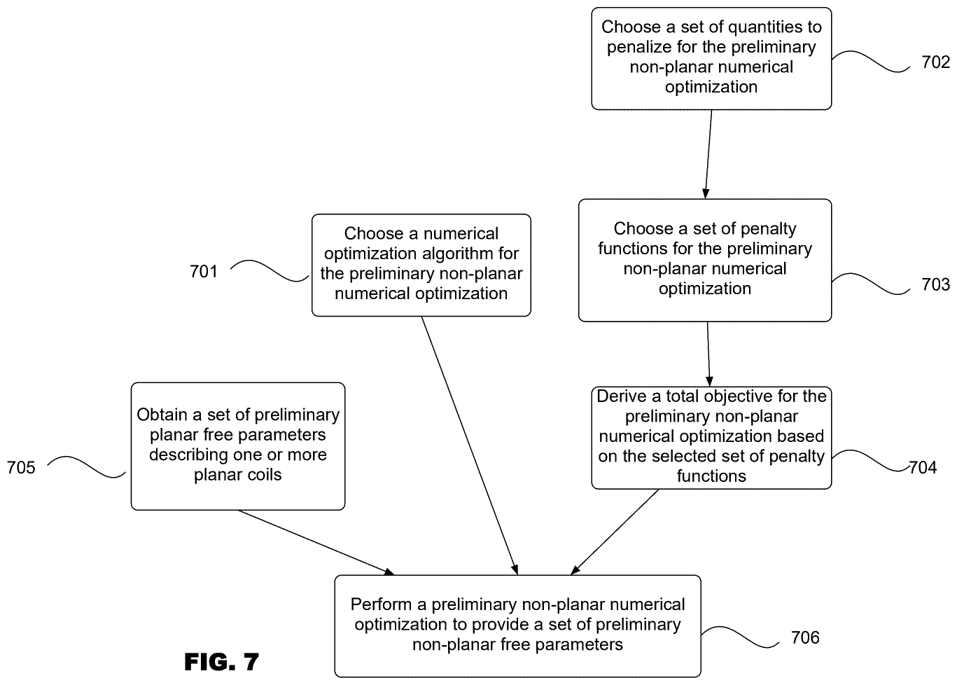

Next, a set of preliminary non-planar free parameters describing one or more non-planar coils is obtained. Methods of obtaining the one or more preliminary non-planar free parameters are described herein (see, e.g., FIG. 7).

### Generation of One or More Sets of Candidate Torsion-Restricted Free Parameters

Subsequently, one or more sets of candidate torsion-restricted free parameters are iteratively generated and evaluated to determine whether any set of candidate torsion-restricted free parameters describe one or more coils which are substantially planar, i.e., whether any set of candidate torsion-restricted free parameters describe one or more coils all of which have a torsion which is less than a predetermined value. Given that the total objective function is derived from a combination of two or more penalty functions where at least one of the two or more penalty functions describes torsion, the total objective function of the torsion-restricting numerical optimization inherently includes a penalty function describing torsion.

With reference to FIGS. 5B and 5C, an initial torsion-restricting numerical optimization is performed to generate an initial set of candidate torsion-restricted free parameters, where the initial torsion-restricted numerical optimization is based on the obtained one or more preliminary non-planar free parameters, the selected numerical optimization algorithm, and the derived total objective function (step 514). The result of the initial torsion-restricted numerical optimization is an initial set of candidate torsion-restricted free parameters.

In some embodiments, at least two torsion-restricting optimizations are performed (see steps 514 and 519). In other embodiments, at least three torsion-restricting optimizations are performed. In other other embodiments, at least four torsion-restricting optimizations are performed. In other other embodiments, at least six torsion-restricting optimizations are performed. In those embodiments where more than one torsion-restricting numerical optimization is performed, in some embodiments, one or more parameters of the torsion penalty function are altered (step 518). For example, in some embodiments, the weight of the penalty function describing torsion in the torsion penalty function is altered; the exponent of the penalty function describing torsion in the torsion penalty function is altered; and/or the target torsion (τ₀) is altered. (see Formula II, herein). In some embodiments, one or more of the parameters of the torsion penalty function are increased, while one or more of the parameters of the torsion penalty function are decreased. For instance, a weight of the torsion penalty function may be increased while a target torsion is decreased. In those embodiments where more than one torsion-restricting numerical optimization is performed, in other embodiments, the weight of at least the penalty function describing torsion (“torsion penalty function”) included within the obtained total objective function is increased to provide a revised total objective function (see step 523).

In this regard, each torsion-restricted numerical optimization utilizes a different total objective function, where each different total objective function differs in the torsion parameters utilized, such as at least in the weight of the torsion penalty function incorporated therein. By way of example, in embodiments where first and second torsion-restricting numerical optimizations are performed, the weight of a torsion penalty function incorporated in the total objective function utilized in the second torsion-restricted numerical optimization is increased relative to the weight of a torsion penalty function incorporated in the obtained total objective function used in the first torsion-restricted numerical optimization.

A torsion parameter may then be computed based on the initial set of torsion-restricted free parameters (step 515). In some embodiments, the torsion parameter is an average of the torsion of each point along the curve described by the candidate torsion-restricted free parameters. In other embodiments, the torsion parameter is the maximum torsion of all points along the curve described by the candidate torsion-restricted free parameters. In yet other embodiments, the torsion parameter is the weighted average or root-mean-square of the torsion of each point along the curve described by the candidate torsion-restricted free parameters.

The generated torsion parameter may then be compared to a predetermined threshold value for torsion (step 516). In some embodiments, the predetermined threshold value for torsion is 0.1/m. In some embodiments, the predetermined threshold value for torsion is 0.09/m. In some embodiments, the predetermined threshold value for torsion is 0.08/m. In some embodiments, the predetermined threshold value for torsion is 0.07/m. In some embodiments, the predetermined threshold value for torsion is 0.06/m. In some embodiments, the predetermined threshold value for torsion is 0.05/m. In some embodiments, the predetermined threshold value for torsion is 0.04/m. In some embodiments, the predetermined threshold value for torsion is 0.03/m. In some embodiments, the predetermined threshold value for torsion is 0.02/m. In other embodiments, the predetermined threshold value for torsion is 0.01/m. In other embodiments, the predetermined threshold value for torsion is 0.009/m. In some embodiments, the predetermined threshold value for torsion is 0.008/m. In some embodiments, the predetermined threshold value for torsion is 0.007/m. In some embodiments, the predetermined threshold value for torsion is 0.006/m. In some embodiments, the predetermined threshold value for torsion is 0.005/m. In some embodiments, the predetermined threshold value for torsion is 0.004/m. In some embodiments, the predetermined threshold value for torsion is 0.003/m. In some embodiments, the predetermined threshold value for torsion is 0.002/m. In other embodiments, the predetermined threshold value for torsion is 0.001/m.

If the computed torsion parameter is evaluated to be equal to or less than the predetermined threshold value for torsion, the initial set of candidate torsion-restricted free parameters is selected as the torsion restricted free parameters and utilized in downstream processing operations (step 517).

If some embodiments, if the computed torsion parameter is evaluated to be greater than the predetermined threshold value for torsion one or more of the parameters of the torsion penalty function are altered (step 518). For instance, the target torsion may be decreased by about 1%, such as about 5%, such as about 10%, such as about 15%, such as about 20%, such as about 25%, such as about 30%, such as about 40%, such as about 50%, such as about 75%, such as about 90%, with each successive revision of the total objective function. The skilled artisan will appreciate that the weight of the torsion penalty may be concomitantly increased while the target torsion is decreased. For instance, if the target torsion is decreased by about 10%, the target weight may be increased by about 1%, about 5%, about 10%, about 20%, etc.

In other embodiments, if the computed torsion parameter is evaluated to be greater than the predetermined threshold value for torsion, the weight of at least the torsion penalty function included within the obtained total objective function is increased to provide a revised total objective function (see step 523), e.g., increased such as by at least about 5%, increased such as at least by about 10%, increased such as at least by about 20%, increased such as at least by about 30%, increased such as at least by about 40%, increased such as at least by about 50%, increased such as at least by about 60%, increased such as at least by about 70%, increased such as at least by about 80%, increased such as at least by about 90%, increased such as at least by about 100%, increased such as at least by about 120%, increased such as at least by about 150%, etc. In some embodiments, the weight of the torsion penalty function is increased by about 10% for every subsequent torsion-restricting numerical optimization performed. In other embodiments, the weight of the torsion penalty function is increased by a factor of about 2 for every subsequent torsion-restricting numerical optimization performed. In other embodiments, the weight of the torsion penalty function is increased by a factor of about 4 for every subsequent torsion-restricting numerical optimization performed. In other embodiments, the weight of the torsion penalty function is increased by a factor of about 6 for every subsequent torsion-restricting numerical optimization performed. In other embodiments, the weight of the torsion penalty function is increased by a factor of about 8 for every subsequent torsion-restricting numerical optimization performed. In yet other embodiments, the weight of the torsion penalty function is increased by a factor of about 10 for every subsequent torsion-restricting numerical optimization performed. In some embodiments, the target torsion is decreased at the same time that the weight is increased for every torsion-restricting numerical optimization performed.

Subsequently, the torsion-restricted numerical optimization is repeated with (i) the revised total objective function, and (ii) the prior generated set of candidate torsion-restricted free parameters, to provide another set of candidate torsion-restricted free parameters (step 519). Steps 515, 516, 518, and 519 may be repeated one or more times, such as two or more times, such as three or more times, such as four or more times, such as 6 or more times, until the evaluation (step 516) of the computed torsion parameter is equal to or less than the predetermined threshold value for torsion.

### Derivation of a Set of Preliminary Non-Planar Free Parameters

As noted above, a set of preliminary non-planar free parameters are used as inputs in the generation of an initial set of candidate torsion-restricted free parameters (step 514 of FIG. 5B). In some embodiments, the set of preliminary non-planar free parameters are determined by performing a preliminary non-planar numerical optimization (see, e.g., FIG. 7).

With reference to FIG. 7, in some embodiments, a numerical optimization algorithm for the preliminary non-planar numerical optimization is selected (step 701). In some embodiments, the numerical optimization algorithm for the preliminary non-planar numerical optimization is a Quasi-Newton algorithm. In other embodiments, the numerical optimization algorithm for the preliminary non-planar numerical optimization is a Levenberg-Marquardt algorithm. In other embodiments, the numerical optimization algorithm for the preliminary non-planar numerical optimization is an Interior Point method. In other embodiments, numerical optimization algorithm for the preliminary non-planar numerical optimization is an Ellipsoid method. In other embodiments, numerical optimization algorithm for the preliminary non-planar numerical optimization is a Broyden-Fletcher-Goldfarb-Shanno algorithm. In other embodiments, the numerical optimization algorithm for the preliminary non-planar numerical optimization is a Conjugate Gradient method. In other embodiments, the numerical optimization algorithm for the preliminary non-planar numerical optimization is a Gradient Descent algorithm. In other embodiments, the numerical optimization algorithm for the preliminary non-planar numerical optimization is L-BFGS-B, which is a variation of the Broyden-Fletcher-Goldfar-Shanno algorithm.

Subsequently, one or more quantities to penalize for the preliminary non-planar numerical optimization are selected (step 702). In some embodiments, the one or more quantities to penalize for the preliminary non-planar numerical optimization are selected from magnetic field error, coil-plasma distance, coil curvature (such as defined by the Frenet-Serret formulae), and coil-to-coil spacing.

Next, one or more penalty functions for the preliminary non-planar numerical optimization are selected (step 703), where each one of the one or more penalty functions describes one of the one or more quantities for penalization selected for the preliminary non-planar numerical optimization. Following the selection of the one or more penalty functions for the preliminary non-planar numerical optimization, a total objective function for the preliminary non-planar numerical optimization is derived by combining the one or more penalty functions for the preliminary non-planar numerical optimization (step 704).

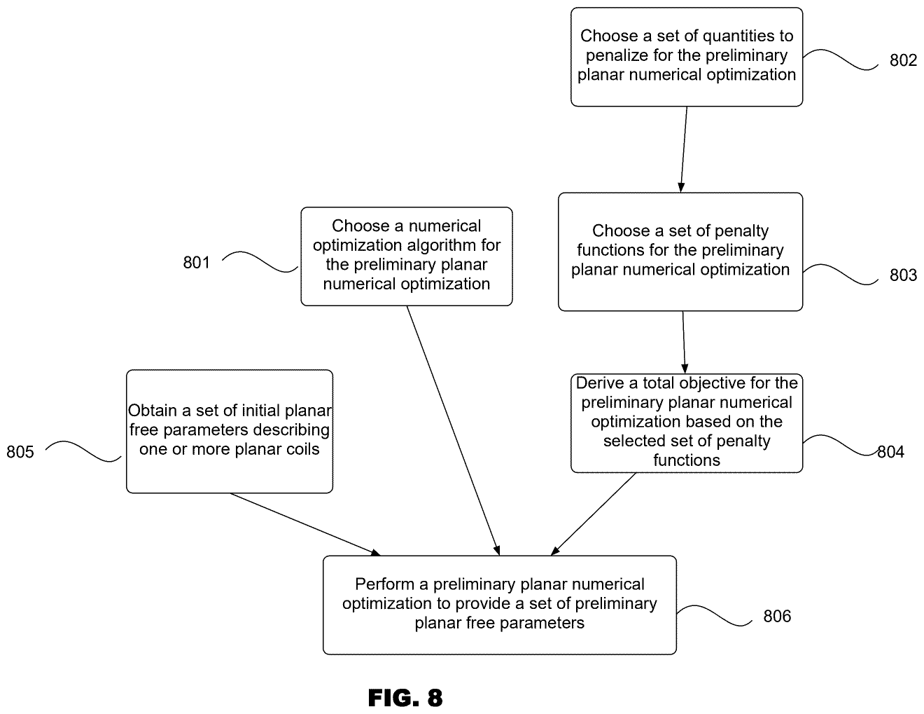

Subsequently, a set of preliminary planar free parameters are derived which describe planar electromagnetic coils (step 705). An exemplary method of deriving the one or more preliminary planar free parameters is set forth herein (see, e.g., FIG. 8).

A preliminary-non-planar numerical optimization is then performed based on the one or more derived preliminary planar free parameters and the derived total objective function for the preliminary non-planar numerical optimization (step 706). The output of the preliminary non-planar numerical optimization is a set of preliminary non-planar free parameters, which may be utilized when performing an initial torsion-restricted numerical optimization (step 514 of FIG. 5B or 5C).

Alternatively, the set of preliminary non-planar free parameters are produced by the output of a current-potential-based algorithm such as NESCOIL (Merkel, P. Nuclear Fusion 27, no. 5 (May 1, 1987): 867.) or REGCOIL (Landreman, Matt. Nuclear Fusion 57, no. 4 (February 2017): 046003.). These algorithms use a non-optimizer based algorithm to produce a design of one or more non-planar electromagnetic coils. In some embodiments, the mean filament of the one or more coils are found as isosurfaces of a scalar current potential which is obtained by a regularized pseudoinverse of a magnetic Green's function.

### Derivation of a Set of Preliminary Planar Free Parameters

As noted above, in some embodiments the preliminary planar free parameters are determined by a preliminary planar numerical optimization. With reference to FIG. 8, the method generating a set of preliminary planar free parameters begins by selecting a numerical optimization algorithm for the preliminary planar numerical optimization (step 801). The numerical optimization algorithm selected for the preliminary planar numerical optimization may be the same or different as the numerical optimization algorithms utilized for the torsion-restricted number optimization or the preliminary non-planar numerical optimization. In some embodiments, one or more quantities to penalize for the preliminary planar numerical optimization (e.g., magnetic field error, coil-plasma distance, coil curvature (such as defined by the Frenet-Serret formulae), and coil-to-coil spacing) are selected (step 802). Next, one or more penalty functions for the preliminary planar numerical optimization are selected (step 803), where each one of the one or more penalty functions for the preliminary planar numerical optimization describes the one of the one or more quantities selected for penalization for the preliminary planar numerical optimization. Following the selection of the one or more penalty functions for the preliminary planar numerical optimization, a total objective function for the preliminary planar numerical optimization is derived by combining the one or more penalty functions for the preliminary planar numerical optimization (step 804).

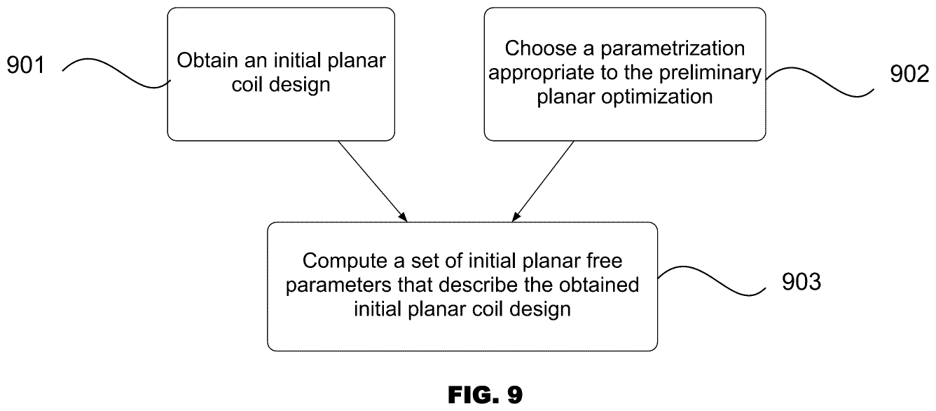

Subsequently, one or more initial planar free parameters are computed describing an initial design of one or more substantially planar coils (step 805). Methods of computing one or more initial planar free parameters are described herein (see, e.g., FIG. 9).

In some embodiments, a preliminary planar numerical optimization in performed (step 806) based on the one or more initial planar free parameters and the total objective function for the preliminary planar numerical optimization. The output of the preliminary planar numerical optimization optimization is a set of preliminary planar free parameters (which may be utilized in the preliminary non-planar numerical optimization set forth in FIG. 7).

In some embodiments, the one or more initial planar free parameters describe a set of rotationally symmetric, circular coils. In some embodiments, the one or more initial planar free parameters describe a set of coils which are placed and rotated rotationally symmetrically around a common axis.

### Computation of a Set of Initial Planar Free Parameters

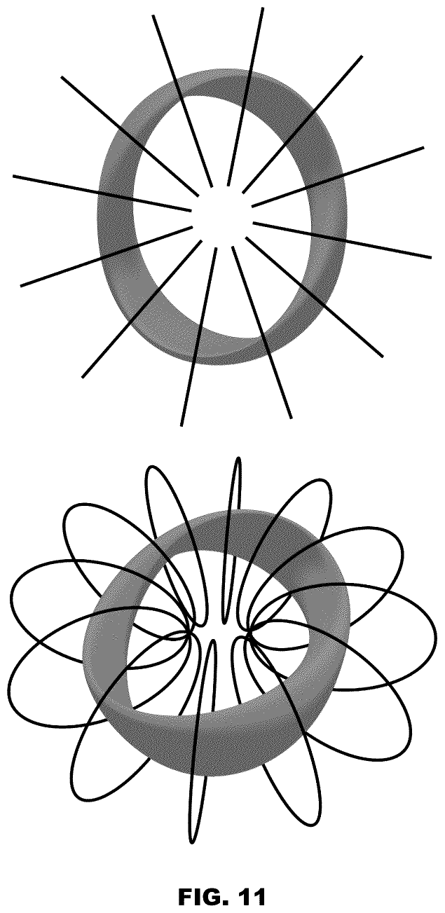

With reference to FIG. 9, an initial planar coil design is obtained, describing one or more planar coils (step 901). In some embodiments, the initial planar free coil design describes a set of rotationally symmetric, circular coils. In some embodiments, the initial planar coil design describes a set of coils which are placed and rotated rotationally symmetrically around a common axis. FIG. 11 illustrates a top-down view of an exemplary initial planar coil design which describes a set of circular coils that are placed and rotated rotationally symmetrically about a common axis (top). FIG. 11 also illustrates a perspective view of the same exemplary coil design (bottom).

In embodiments where the initial planar coil design describes a set of circular coils that are placed and rotated rotationally symmetrically about a common axis, the skilled artisan would appreciate that the center of each coil should be about where the major radius of the plasma torus is, and the coil radius should be larger than the plasma minor radius. In some embodiments, the choice of coil minor radius is toroidally dependent (not rotationally symmetrical) because the major/minor radius of the plasma may vary significantly as one moves in the toroidal direction.

In some embodiments, the choice of a rotationally symmetric initial planar coil design necessarily entails a choice of an initial radius of the coils and a radial distance from the origin of a coordinate system to a coil center. In some embodiments, a fixed constraint from the plasma (e.g., the toroidal magnetic flux) determines the sum of the electrical current carried by all initial planar coils.

In some embodiments, the desired number of initial planar coils ranges from between about about 2 coils to about about 100 coils. In other embodiments, the desired number of coils ranges from between about about 2 coils to about about 50 coils. In yet other embodiments, the desired number of coils ranges from between about about 2 coils to about about 20 coils. In further embodiments, the desired number of coils ranges from between about about 2 coils to about about 16 coils. In further embodiments, the desired number of coils ranges from between about about 2 coils to about about 12 coils.

In some embodiments, the initial radius of the coils of the initial planar coil design ranges from between about 1 cm to about 500 cm. In other embodiments, the initial radius of the coils ranges from between about 1 cm to about 400 cm. In yet other embodiments, the initial radius of the coils ranges from between about 50 cm to about 300 cm. In yet other embodiments, the initial radius of the coils ranges from between about 60 cm to about 200 cm.

In some embodiments, the initial radial distance of each coil of the initial planar coil design ranges from about 1 m to about 15 m. In other embodiments, the radial distance ranges from about 1 m to about 11 m. In yet other embodiments, the radial distance ranges from about 1.5 m to about 8.0 m. In yet other embodiments, the radial distance ranges from about 2.0 m to about 5.0 m.

After the initial planar coil design is obtained (step 901), a parametrization appropriate for a preliminary planar optimization is chosen (step 902). Parametrizations appropriate for a preliminary planar optimization are those which are able to describe only planar coils. In some embodiments, the parametrization appropriate for a preliminary planar optimization is a Fourier representation (inverse Fourier transform) that uses only mode numbers 0 and 1. In other embodiments, the parametrization appropriate for a preliminary planar optimization is a Fourier representation in only the X-Y plane, and three Euler angles to rotate the planar coil into an arbitrary plane. Next, a set of initial planar free parameters are computed using the parametrizing function of the chosen parametrization. These initial planar free parameters describe the obtained initial planar coil design.

With reference to FIG. 11, the upper figure illustrates a top-down view of an initial planar coil design which describes a set of circular coils that are placed and rotated rotationally symmetrically about a common axis. The lower figure illustrates a perspective view of the same coil design.

### Post-Processing

In some embodiments a post-processing step is performed after the set of torsion-restricted free parameters are identified. In some embodiments, a set of revised torsion-restricted free parameters are computed which describe one or more coils which are planar. In some embodiments, the set of revised torsion-restricted free parameters are computed by: 1) deriving a mean filament of a coil design described by the set of torsion-restricted free parameters; 2) identifying a mean plane of the mean filament; 3) projecting the mean filament onto the mean plane; and 4) computing the set revised torsion-restricted free parameters which describe the projected mean filament.

In some embodiments, the inverse parametrizing function is applied to either the set of torsion-restricted free parameters or the revised set of torsion-restricted free parameters to compute a design for one or more substantially planer coils or one or more planar coils, respectively.

### EXAMPLES

Described below are certain non-limiting methods of generating a coil array, such as a coil array for a stellarator, such as planar encircling coils for a stellarator.

### Example 1

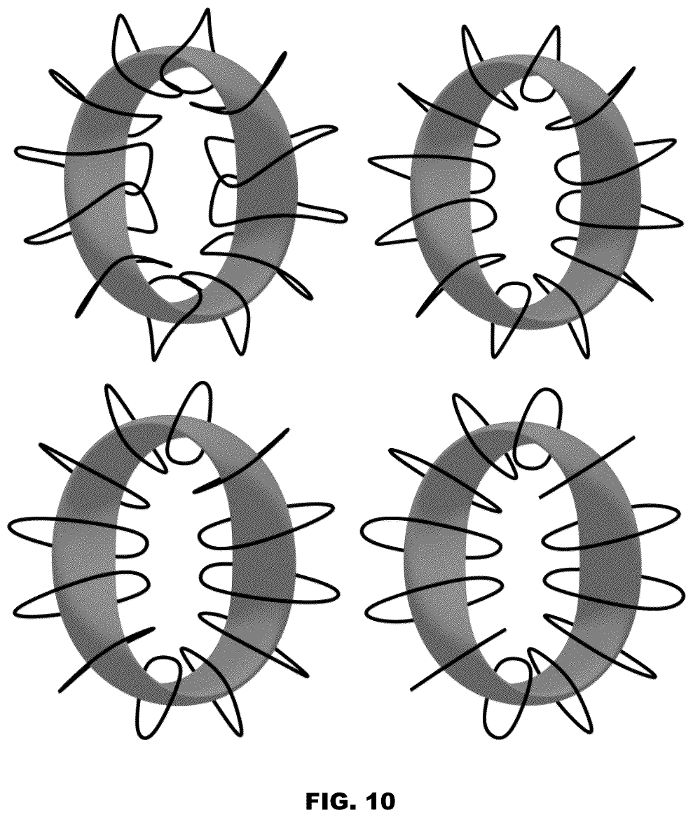

FIG. 10 provides several coil designs resulting from the computation of one or more sets of free parameters in accordance with the methods described herein. In particular, FIG. 10 demonstrates the results of a preliminary non-planar numerical optimization (upper left) with a target torsion of 0.4 m⁻¹ and weight of 1.0. The upper right image provides a result from a first torsion-restricting numerical optimization using a target torsion of 0.1 m⁻¹ and weight of 10. The lower left portion of FIG. 10 illustrates a result from a second torsion-restricting numerical optimization using a target torsion of 0.05 m⁻¹ and weight of 100. The lower right portion of FIG. 10 provides a third and final result from a third and final torsion-restricting numerical optimization using a target torsion of 0.0 m⁻¹ and weight of 10000. In FIG. 10, each total objective function includes penalty functions describing magnetic error, a coil-to-plasma distance, coil length, coil-to-coil distance, and torsion.

The initial guess of the preliminary non-planar numerical optimization (upper left figure) was a preliminary planar coil design, obtained using a preliminary planar optimization. The preliminary planar numerical optimization used particular values/weights for each penalty function and a parametrization which was able to describe only planar coils. The parametrization was a Fourier representation including only Fourier mode numbers of 0 and 1. To arrive at the first figure (upper left), the preliminary non-planar numerical optimization used a parametrization, also a Fourier representation but including modes that can introduce torsion (mode number greater than 1). The preliminary non-planar numerical optimization used a total objective function whose torsion target/weight was set to values that would allow significant torsion. The preliminary non-planar numerical optimization was run for a fixed number of iterations. This resulted in the upper left image in FIG. 10, where the coils are shown to have a large amount of torsion to satisfy the total objective function of this optimization. The positions of the coils and the specific locations of where the coil twists are numerical optimization results that best minimize the second total objective function.

As compared with the upper left figure, the upper right figure shows the result of a first torsion-restricting numerical optimization which uses a first total objective function which includes a penalty function that describes torsion with a high weight. In particular, the penalty function that describes torsion was given more weight and the target torsion was decreased. The first torsion-restricting numerical optimization was run for a fixed number of iterations. The result was one or more torsion-restricted free parameters which describe a torsion-restricted coil design with considerably less torsion than the first figure (upper left), indicating that the numerical optimization was behaving as expected in regard to targeting torsion. Again, the positions of the coils and the specific locations of where the coil twists were numerical optimization results that best minimized the first total objective function.

The final two images (bottom left and bottom right) follow the same pattern of successive torsion-restricting numerical optimization, increasing the weight of the torsion penalty and decreasing the target torsion. By the final image in the bottom right, the curves have substantially zero torsion and are substantially planar.

### Example 2

In some embodiments, the implementation of the methods of the present disclosure utilizes a truncated Fourier series to represent the shape of curves in the numerical optimization process, a parametrization of a Fourier representation. For example, in a Cartesian coordinate system, the x-coordinate of a point along the curve would be:

$$x ( θ ) = {\sum }_{m = 0}^{order} {x}_{c , m} cos ( m θ ) + {\sum }_{m = 1}^{order} {x}_{s , m} sin ( m θ ) \qquad ( Formula III )$$

where x_{c,m} and x_{s,m} are some of the free parameters: cosine and sine amplitudes of order m, respectively, and theta parameterizes the distance along the curve. These amplitudes, which control the shape of the curve, are the main free parameters in the coil numerical optimization (with coil currents being other free parameters).

To create initial, planar free parameters, the parametrization used in the preliminary planar optimization includes only Fourier amplitudes with m=0 or m=1. This implies a planar curve. Once a preliminary planar numerical optimization is complete, the preliminary planar free parameters use a parametrization which includes higher m>=2 mode, introducing torsion to the curve.

The parametrization used by the torsion-restricting optimizations in this implementation is the same as that used in the preliminary non-planar optimization. The torsion penalty function used in this implementation uses Formula II with p=2, C=1/2, and does not include the Heaviside function. The target torsion, τ₀, is initially set to a relatively high value. In this implementation, in the torsion-restricting optimizations the optimizer is run for a limited number of iterations, after which the torsion target is decreased, and the weight is increased. In this implementation, this process is repeated until the torsion target is zero and the weight is commensurate with the other penalty functions in the total objective function. At this point, the revised torsion-restricted free parameters describe one or more coils which are substantially planar and include optimal shaping contributions from modes that, by their nature, would otherwise introduce torsion into the curve.

### Example 3

The zeroth step in generating an optimized coil set is the creation of a plasma equilibrium for which the coils will be designed. The equilibrium chosen was a 2-field period equilibrium with a finite plasma pressure, which implied the existence of a current within the plasma. This current produced a normal magnetic field on the boundary of the plasma that was determined so that the total objective function in the coil numerical optimization can be specified correctly.

Next, the initial conditions for the numerical optimization were set up. It was chosen to have 3 unique coils per half field period. For a 2-field period equilibrium that was stellarator symmetric, this led to 12 total coils. The 12 coils were initialized as circles with a 2 m radius that were equally spaced in toroidal angle. To initialize the current in each coil the toroidal magnetic flux from the chosen equilibrium was needed, which was used to determine the sum of the current in the optimized coils. This total current was divided equally among the 12 coils, which provided the initial current in each coil.

The coils were then parametrized by selecting:

The order of the Fourier series that was used to represent the shape (order=5). This set the number of Fourier coefficients that could have been used as free parameters. Specifically, there is a Fourier series for each Cartesian coordinate (x, y, z), and there are 2*order+1 coefficients per Fourier series. For this case, order=5 was selected, which corresponded to 33 Fourier amplitudes plus one electric current, together being the free parameters that describe each coil.

The integrals of the penalty functions were evaluated only to some finite accuracy. A finite number of quadrature points were used. numquadpoints=512 was selected.

The total objective function was set next by specifying the penalty functions. The objective for minimizing the normal magnetic field on the surface was specified by using the normal field found in the virtual casing calculation as the “target” field. The minimum plasma-coil distance was set to 75 cm. The minimum coil-coil distance was set to 25 cm. The individual coil length target was set to 10 m. The initial weight for each of these penalty functions was set to 1.0. Finally, it should be noted that the coil torsion weight was set to zero, making the target torsion irrelevant. The exponent in (Formula II) was set to p=2.

The current in all the coils was chosen to be fixed, and all Fourier coefficients with m>1 were fixed for the parametrization for the preliminary planar numerical optimization. This prevented any coil torsion developing once the preliminary planar numerical optimization began.

Once the aforementioned was finalized, the iterative preliminary planar numerical optimization procedure was initiated. For this numerical optimization, 50 iterations were used at each step with the conjugate gradient algorithm. In principle, the algorithm and/or the number of iterations could change between steps. One of the most important things that were checked for after each step were any potential intersections between the coil and the plasma, and between the coils themselves. The following lists step-by-step what was changed with respect to the total objective function.

Step 1—Optimize using initial conditions discussed above. The maximum normal magnetic field error was 1.361 T. The mean normal magnetic field error was 0.475 T. The resulting minimum plasma-coil distance was about 54 cm, well below the desired 75 cm. The resulting minimum coil-coil distance was about 90 cm, easily satisfying the target. The individual coil lengths were each around 10.6 m, close to the target. The minimum coil-coil distance does not get close to the minimum target for the entirety of the optimization, so it is not referenced again in the steps. Additionally, the coils lengths always stay between 10-11 m, which was deemed to be acceptable. Coil lengths will also not be referenced again in the steps that follow.

Step 2—The weight on the plasma-coil distance penalty function was increased from 1 to 10. The coils were then re-optimized. The maximum normal magnetic field error was about 1.270 T. The mean normal magnetic field error was 0.487 T. The minimum plasma-coil distance was about 61 cm, still not close enough to the target.

Step 3—The weight on the plasma-coil distance penalty function was increased from 10 to 100. The coils were then re-optimized. The maximum normal magnetic field error was about 1.256 T. The mean normal magnetic field error was 0.503 T. The minimum plasma-coil distance was about 68 cm, still not close enough to the target.

Step 4—The weight on the plasma-coil distance penalty function was increased from 100 to 1000. The coils were then re-optimized. The maximum normal magnetic field error was about 1.275 T. The mean normal magnetic field error was 0.512 T. The minimum plasma-coil distance was about 72 cm, which was determined to be sufficient.

Step 5—The m=0, 1 Fourier modes were fixed next, while the m=2, 3 Fourier modes were allowed to vary. The weight of the torsion penalty was set to 1.0 and the target torsion value was set to be 0.4 m−1. The coils were then re-optimized. The result was a set of highly non-planar coils where the maximum normal magnetic field error was 0.81 T. The mean normal magnetic field error was 0.184 T.

Step 6—The m=2, 3 Fourier modes were fixed next, while the m=0, 1 Fourier modes were allowed to vary. The coils were then re-optimized. This step retains the torsion that resulted from Step 5 and attempted to further minimize the normal magnetic field by modifying the non-torsion introducing modes. The maximum normal magnetic field error was 0.59 T. The mean normal magnetic field error was 0.178 T.

Step 7—The m=0, 1 Fourier modes were fixed next, while the m=2, 3 Fourier modes were allowed to vary. The weight of the torsion penalty was set to 10.0 and the target torsion value was set to be 0.1 m⁻¹. The coils were then re-optimized. The maximum normal magnetic field error was 0.96 T. The mean normal magnetic field error was 0.362 T.

Step 8—The m=2, 3 Fourier modes were fixed next, while the m=0, 1 Fourier modes were allowed to vary. The coils were then re-optimized. The maximum normal magnetic field error was 0.90 T. The mean normal magnetic field error was 0.354 T.

Step 9—The m=0, 1 Fourier modes were fixed next, while the m=2, 3 Fourier modes were allowed to vary. The weight of the torsion penalty was set to 100.0 and the target torsion value was set to be 0.05 m⁻¹. The coils were then re-optimized. The maximum normal magnetic field error was 1.08 T. The mean normal magnetic field error was 0.441 T.

Step 10—The m=2, 3 Fourier modes were fixed next, while the m=0, 1 Fourier modes were allowed to vary. The coils were then re-optimized. The maximum normal magnetic field error was 1.06 T. The mean normal magnetic field error was 0.430 T.

Step 11—The m=0.1 Fourier modes were fixed next, while the m=2, 3 Fourier modes were allowed to vary. The weight of the torsion penalty was set to 1000.0 and the target torsion value was set to be 0.01 m⁻¹. The coils were then re-optimized. The maximum normal magnetic field error was 1.161 T. The mean normal magnetic field error was 0.482 T.

Step 12—The m=2, 3 Fourier modes were fixed next, while the m=0, 1 Fourier modes were allowed to vary. The coils were then re-optimized. The maximum normal magnetic field error was 1.156 T. The mean normal magnetic field error was 0.475 T.

Step 13—The m=0, 1 Fourier modes were fixed next, while the m=2, 3 Fourier modes were allowed to vary. The weight of the torsion penalty was set to 10000.0 and the target torsion value was set to be 0.0 m⁻¹. The coils were then re-optimized. The maximum normal magnetic field error was 1.196 T. The mean normal magnetic field error was 0.495 T. The coils were then substantially planar.

### Example 5—Coil Numerical Optimization Methods

This example provides an exemplary method of generating a set of torsion-restricted free parameters that describe a set of substantially planar electromagnetic coils for confining a plasma within a stellarator. This set of coils contains 12 coils, though 9 of them are duplicates, leaving only 3 unique coils. Several penalty functions are included, notably the penalty function for the magnetic field error, which causes the described coils to generate a magnetic field which is very close to the target magnetic field.

### Overview of Coil Numerical Optimization

The idea of optimizing magnetohydrodynamic equilibria to have desirable properties is only half of the numerical optimization problem. In order to realize such an equilibrium, one must create electromagnetic coils that can actually produce it. The difficulty in finding currents that produce a desired magnetic field is that it is a fundamentally ill-posed problem (M Landreman. Nuclear Fusion, 57(4): 046003, 2017). This is to say that coil numerical optimization is an under-determined problem, where different coils can produce the same magnetic field. A unique coil solution for a given equilibrium, therefore, does not exist. This fact has led to the development of a variety of approaches and codes to find an optimal solution.

The pioneering method of coil design was devised by Merkel (P Merkel. Nuclear Fusion, 27(5): 867, 1987.) and was implemented in the code NESCOIL (and later, the regularized version REGCOIL (M Landreman. Nuclear Fusion, 57 (4): 046003, 2017)). This approach uses the concept of a coil winding surface on which a current potential is calculated that best produces the desired magnetic field. Discrete filaments can then be “cut” from contours of current potential, and are used to represent electromagnetic coils, typically a series of modular coils. This approach is simple from a user standpoint in the sense that it only requires the choice of a winding surface and resolution of the current potential. However, its utility is limited due to its inability to address important engineering constraints such as minimum coil-coil separation, maximum curvature, etc.

New strategies emerged to directly optimize coil geometries [(C Zhu, S Hudson, Y Song, and Y Wan. Nuclear Fusion, 58(1): 016008, 2017), (T. Brown, J. Breslau, D. Gates, N. Pomphrey, and A. Zolfaghari 2015 IEEE 26th Symposium on Fusion Engineering (SOFE), pages 1-6, 2015), (Matt Landreman, Bharat Medasani, Florian Wechsung, Andrew Giuliani, Rogerio Jorge, and Caoxiang Zhu. Journal of Open-Source Software, 6(65): 3525, 2021.)] as a means to include such engineering constraints in the numerical optimization. One of these strategies was to parameterize modular coil geometries with a three-dimensional Fourier series:

$$x ( ζ ) = {x}_{0}^{c} + {\sum }_{m = 1}^{M} [ {x}_{m}^{c} cos ( m ζ ) + {x}_{m}^{s} sin ( m ζ ) ] \\ y ( ζ ) = {y}_{0}^{c} + {\sum }_{m = 1}^{M} [ {y}_{m}^{c} cos ( m ζ ) + {y}_{m}^{s} sin ( m ζ ) ] \\ z ( ζ ) = {z}_{0}^{c} + {\sum }_{m = 1}^{M} [ {z}_{m}^{c} cos ( m ζ ) + {z}_{m}^{s} sin ( m ζ ) ]$$

Fourier mode amplitudes can be perturbed to directly change the coil's geometry, allowing for the explicit application of engineering constraints. Unfortunately, approaches like this require the solution of a nonlinear numerical optimization. Details of our approach to this problem, including additional coil parameterizations, are described below.

### Objective Functions

Coils for the all-planar stellarator are designed through a series of nonlinear numerical optimizations. This nonlinear numerical optimization problem can be expressed compactly as a weighted sum of objective functions:

$$min {\sum }_{i} {w}_{i} {f}_{i} ( x ) \qquad ( Formula IV )$$

$$subject to {g}_{j} ( x ) \leq 0 \qquad ( Formula V )$$

$${h}_{k} ( x ) = 0. \qquad ( Formula VI )$$

The objective functions, ƒᵢ, are dependent on coil geometries and currents which will be perturbed to minimize said objectives. The numerical optimization is also subject to a list of constraints given by the functions, gⱼ and hₖ. The primary purpose of this numerical optimization is to reconstruct a desired equilibrium's magnetic field. This is typically done by targeting the normal magnetic field on the equilibrium's plasma boundary. The squared quadratic flux on the plasma boundary (field error) is calculated with the following objective function.

$${f}_{Bn} = {\int }_{S} {( B \cdot \hat{n} - {Y}_{Bn} )}^{2} dS , \qquad ( Formula VII )$$

where B is the magnetic field produced by the coils, \hat{n} is the normal of the plasma boundary S, and T_{Bn} is the target normal magnetic field defined by the plasma currents (T_{Bn}=0 in a vacuum equilibrium). Formula (VII) is one of many fᵢ objectives that will be minimized during numerical optimization. If ƒ_{Bn}=0, then the equilibrium's plasma boundary is reconstructed perfectly. However, this rarely happens in coil numerical optimization, especially with the addition of engineering constraints.

Normal field errors are minimized subject to many engineering constraints. These constraints can be broken down into two types, linear and nonlinear. The total linking current is the only linear constraint used to optimized coils in this paper. The sum of the encircling coil currents is set constant in order to generate the necessary toroidal flux. This constraint is satisfied perfectly throughout a numerical optimization by using a relatively simple Lagrange multiplier.

All of the remaining engineering constraints are nonlinear and imposed with penalty functions [Thomas G Kruger, C Zhu, A Bader, DT Anderson, and L Singh. 87(2): 175870201, 2021.]. Penalty functions increase as the constraint violation increases, effectively quantifying how infeasible a solution is. New objective functions incorporate these penalty functions and are added to the normal field error objective in Equation (iv). The penalty function's weight is increased throughout the course of a numerical optimization until the constraint violation is considered small enough.

### Engineering Constraints

While minimizing the normal field error on the plasma boundary is the principal purpose of coil numerical optimization, this must be done subject to a variety of engineering constraints. The engineering constraints discussed in this chapter are all nonlinear and will be posed as objective functions with the use of penalties.

The first engineering constraint that will be discussed is a constraint on the maximum coil curvature. Each coil's curvature, κᵢ is constrained to be less than some user defined value, κ₀. The objective function used to impose this constraint is given as,

$${f}_{κ} = \frac{1}{{N}_{c}} {\sum }_{i = 1}^{{N}_{c}} \frac{1}{{L}_{i}} {\int }_{0}^{2 π} {H ( {κ}_{i} - {κ}_{0} )}^{2} \vert {r}_{i}^{′} \vert d ζ \qquad ( Formula VIII )$$

$${κ}_{i} = \frac{\vert {r}_{i}^{′} \times {r}_{i}^{″} \vert}{{\vert {r}_{i}^{′} \vert}^{3}} \qquad ( Formula IX )$$

where H is a Heaviside function used to only penalize constraint violations (κi>κ0), is the coil's arc length, and Nc is the total number of coils being optimized. The curvature penalty is integrated along the arc length of each coil and is normalized by the total length of the coil, Li. Again, the weight of this penalty, wκ will be increased throughout the course of a numerical optimization until the constraint violation is deemed acceptable.

Coil convexity also depends on the coil's curvature, but its penalty takes a unique form. This is the only nonlinear constraint that does not use a quadratic penalty function. The total (integrated) curvature quantifies how non-convex a coil is. The total curvature is equal to 2π if and only if the coil is convex. The convexity constraint is applied with the following objective function:

$${f}_{conv} = {\sum }_{i = 1}^{{N}_{c}} {\int }_{0}^{2 π} {κ}_{i} \vert {r}_{i}^{′} \vert d θ - 2 π \qquad ( Formula IX )$$

which is zero when the coil is convex and increases in magnitude as the coil moves further away from being convex. Again, the weight of this convexity penalty is increased throughout the numerical optimization until the coils are convex enough.

The minimum coil-to-coil separation also needs to be constrained in order for the filamentary coils to be feasible. Coil cross-sections cannot intersect at the very least. The objective function used to impose this constraint is given as,

$${f}_{cc} = \frac{2}{{N}_{c} ( {N}_{c} - 1 )} {\sum }_{i = 1}^{{N}_{c} - 1} {\sum }_{j = i + 1}^{{N}_{c}} \frac{1}{{L}_{i} {L}_{j}} {\int }_{0}^{2 π} {\int }_{0}^{2 π} H ( {r}_{Δ} - \vert {r}_{i} - {r}_{j} \vert ) {( {r}_{Δ} - \vert {r}_{i} - {r}_{j} \vert )}^{2} \vert {r}_{i}^{′} \vert d {ζ}_{i} \vert {r}_{j}^{′} \vert d {ζ}_{j} \qquad ( Formula XI )$$

where distances between coils are kept above some minimum value, r_{Δ}. The double summation in this objective picks out only the unique pairs of coils. The penalty is once again integrated over the coils' arc lengths and is normalized by the total coil lengths. Integration over the coils' arc lengths is necessary to keep the objective independent of the coil's parameterization.

The final engineering constraint discussed in this section is a constraint on the minimum coil-to-plasma distance. The objective used to apply this constraint is given as,

$${f}_{cs} = \frac{1}{{N}_{c}} {\sum }_{i = 1}^{{N}_{c}} \frac{1}{{L}_{i}} {\int }_{0}^{2 π} {\int }_{S} H ( {r}_{δ} - \vert {r}_{s} - {r}_{i} \vert ) {( {r}_{δ} - \vert {r}_{s} - {r}_{i} \vert )}^{2} dS \vert {r}_{i}^{′} \vert d ζ \qquad ( Formula ( XII )$$

where r_{δ} is the minimum distance, rᵢ is the point on the coil, and rₛ is the point on the plasma boundary. This constraint is added to the coil numerical optimization in order to leave sufficient room for a neutron shield and blanket.

The objectives discussed in this section are all made to be differentiable for use in gradient based numerical optimizations. The objectives are also independent of a coil's specific parameterization. The coil does, however, need to be sufficiently smooth in order to evaluate some of the penalties. Below we will discuss a coil parameterization, which is infinitely differentiable.

### Torsion Penalty

The methodology used here takes a two-part numerical optimization approach. Step 1 is to optimize only the m=0 and m=1 Fourier coefficients, keeping the 1<m<M coefficients fixed to zero. The coil shapes are restricted to planar ellipses by only using this limited set of modes. The solution of this numerical optimization is then used to initialize coils in the next step. Step 2 then relaxes the planarity of the coil by unfixing some or all of the m>1 modes in Formulae (III), while also introducing a penalty on the torsion. This penalty is:

$${f}_{τ} = \frac{1}{{N}_{c}} {\sum }_{i = 1}^{{N}_{c}} {\int }_{0}^{2 π} H ( \vert τ \vert - {τ}_{0} ) {( \vert τ \vert - {τ}_{0} )}^{2} \vert {r}_{i}^{′} \vert d ζ \qquad ( Formula XIII )$$

where τ₀ is the maximum magnitude of local torsion. Using f_{τ} with a low weight and a relatively nonrestrictive max torsion to, the coils are re-optimized for a fixed number of iterations. Subsequently, τ₀ is decreased, the weight is increased, and the coils are reoptimized, leading to new coils that are more planar. This process is repeated until the coils have reached the desired level of planarity. The utility of this approach as opposed to using strictly planar coils can be understood by recognizing that the restriction of any non-planarity throughout the numerical optimization can potentially reduce the solution space of the problem. By allowing for finite torsion, the solution space is initially larger, which could lead to finding better local minima in some cases.

### Encircling Coil Numerical Optimization

The first stage of the planar coil numerical optimization is to use a set of encircling coils to minimize the normal magnetic field error on the plasma boundary. The specific engineering constraints that are imposed on the numerical optimization are provided in the Table below. The numerical optimization is performed on a half field period of coils with N_{unique}=3 encircling coils, equating to N_{c}=12 coils for the full torus with N_{ƒp}=2 number of field periods. The natural stellarator symmetry of the plasma boundary allows us to parameterize only coils from the first half field period, which are then copied around the equilibrium, thus greatly reducing the dimensionality of the numerical optimization's solution space.

| | Numerical | Numerical | |
|---|---|---|---|
| | optimization | optimization | |
| Constraint | Target | Results | |
| Maximum curvature | κ₀ = 4 m⁻¹ | 4.08 | m⁻¹ |
| Minimum coil-to-surface | r_{Δ} = 75 cm | 73.4 | cm |
| distance | | | |
| Minimum coil-to-coil | r_{cc} = 50 cm | 62 | cm |
| distance | | | |

| | | |
|---|---|---|
| Convexity | f_{conv} = 0 | 0.0018 |

Encircling coil numerical optimization is initialized with circular coils that are equally spaced in the toroidal angle. Engineering objective functions are initialized with small weights in order for the coils to minimize normal field errors. These weights are progressively increased during a series of numerical optimizations until the constraints are satisfied well enough. The numerical optimization achieves a maximum coil curvature of 4.08 m⁻¹, a reasonable constraint violation of roughly 5%. The minimum coil-to-coil distance naturally ended up being 62 cm for the optimized coil set, 12 cm larger than the user-imposed constraint. The minimum distance between the encircling coils and the plasma boundary is 73.4 cm, roughly a 2% constraint violation.

Finally, the coil convexity objective has a value of f_{conv}=0.0018. This value being larger than zero tells us that a coil is slightly concave. However, the concavity is very small, 0.0018<<2π, and the coils do not need to be significantly perturbed in order to become truly convex. Additional numerical optimizations can be performed to minimize the already small constraint violations, however the magnetic field on the plasma boundary will not change significantly. Because of this, the optimized encircling coil set is considered to be feasible with respect to our engineering constraints.

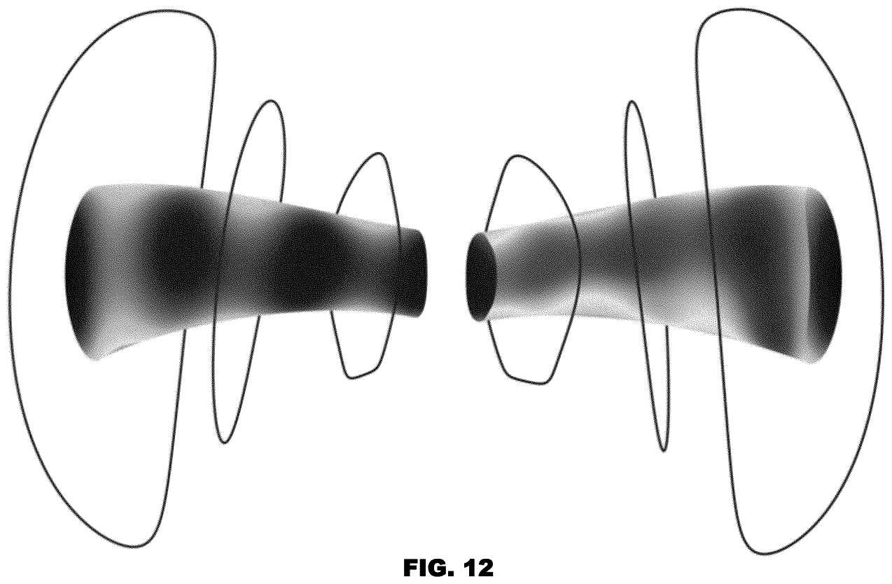

Optimized encircling coils and their magnetic field on the plasma boundary are given in FIG. 12. Encircling coil geometries are clearly motivated by the plasma boundary. The encircling coils follow the magnetic axis closely to generate the equilibrium's axial magnetic field. The magnitude of the magnetic field on the plasma boundary is QA-like, but clearly has symmetry breaking errors such as coil ripple.

The normal magnetic field on the plasma boundary quantitatively determines the quality of the encircling coil set's magnetic field. A plot of the local normal magnetic field error on the plasma surface is given in FIG. 12. The maximum normal field error for this coil set is 0.82 T, roughly an order of magnitude less than the equilibrium's average field strength. The normal magnetic field can be normalized to give us a local percent field error which for this case is 3.3% on average.

### Additional Embodiments

In some embodiments, the torsion-restricting but not final optimizations are run with a small number of iterations and with targets and/or weights that may not be the final desired values. a small number of iterations (e.g., about 10 iterations, about 20 iterations, about 50 iterations, etc.), the targets and/or weights can be adjusted based on the outcome of the optimization. In some embodiments, the targets and/or weights can successively be pushed to values closer to the final desired values. In some embodiments, this process of adjusting targets and/or weights after a small number of iterations can be repeated with targets that are progressively closer to a desired final value, with weights that become larger to more strongly penalize large deviations from the target. In some embodiments, this process of adjusting targets and/or weights after a small number of iterations can be repeated with targets that are progressively closer to a desired final value, with weights that become larger to more strongly penalize large deviations from the target. For example, the operator might want a final minimum coil-coil spacing of 40 cm. They might start the optimization using a coil-coil penalty function with 20 cm target minimum spacing (along with other potential penalty functions). The optimization is then run for 20 (or other number) iterations. The operator then increases the target to 30 cm minimum coil-coil spacing and reruns the optimization for 20 (or other number) iterations. This process continues until resulting coil-coil spacing meets some value desired by the operator.

In some embodiments, for any of the described numerical optimizations, the operator may specify the maximum number of iterations that the optimization algorithm will perform before ending the optimization. The larger the number of iterations, the closer the optimization will be to being “stuck” in a (potentially undesirable) local minimum. By choosing a smaller number of iterations, the result of the optimization may target a subset of local minima (relative to the larger number of possible local minima before the optimization), but the solution space will not be reduced to a single local minimum. This, it is believed, affords some freedom to vary the total objective function at different stages in the optimization to target different plasma and coil properties at different points. In some embodiments, the maximum number of iterations ranges from between 5 to about 200. In other embodiments, the maximum number of iterations ranges from between 10 to about 50. In yet other embodiments, the maximum number of iterations ranges from between 10 to about 20.

In a first additional embodiment, present disclosure is directed to a method of generating an array of substantially planar electromagnetic coils, such as for use in a stellarator. In some embodiments the method of the present disclosure first optimizes the shape of a strictly planar curve. In some embodiments, once the shape of the strictly planar curve is optimized, the strictly planar constraint is removed and the torsion of the curve is allowed to vary. In some embodiments, the target torsion is initially set to a relatively high value with a low relative weight to allow the curve freedom to assume a torsion that will best minimize the total objective function based on other constraints. In some embodiments, an optimization algorithm is run for a limited number of iterations (e.g., between about 5 to about 200 iterations; about 10 to about 50 iterations, about 10 to 20 iterations, etc.), after which the torsion target is decreased, and the weight is increased. This process is repeated until the torsion target is zero and the weight is commensurate with the other penalty functions in the total objective function. The result is a curve that is substantially planar and which includes optimal shaping contributions from modes that, by their nature, would otherwise introduce torsion into the curve.

In a second additional embodiment, disclosure provides a method of generating a substantially planar coil array comprising obtaining an initial coil array; computing a preliminary optimized coil array that is optimized for coil shape, coil position, and coil current; computing a revised optimized coil array having an initial torsion; and iteratively refining the revised optimized coil array until a target torsion of zero is achieved. In some embodiments, the computing of the preliminary optimized coil array comprises: (i) defining one or more input parameters; (ii) initializing a coil array design based on the defined one or more input parameters; (iii) receiving one or more user defined parameters; and (iv) performing a first optimization on the obtained initial coil array based on the received one or more user defined parameters and one or more engineering constraints to provide the preliminary optimized coil array.

In some embodiments, the one or more defined input parameters are selected from the group consisting of a desired number of coils in the planar coil array, a maximum order of a Fourier series, an initial radius of coils, and a radial distance from the origin of a coordinate system to a coil center. In some embodiments, the desired number of coils in the planar coil array ranges from between about 2 coils to about 100 coils. In some embodiments, the desired number of coils in the planar coil array ranges from between about 2 coils to about 50 coils. In some embodiments, the maximum order of the Fourier series ranges from between about 1 to about 20. In some embodiments, the initial radius of the coils ranges from between about 1 to about 500 cm. In some embodiments, the radial distance ranges from about 1 m to about 15 m. In some embodiments, the coil design is initialized to be (i) circular or substantially circular, (ii) equally or substantially equally spaced in the toroidal direction; (iii) have their centers at the prescribed radial distance from the origin, and (iv) have the desired radius. In some embodiments, the one or more user defined parameters comprise amplitudes of a Fourier series. In some embodiments, the one or more user defined parameters comprise one or more optimization algorithms. In some embodiments, the one or more user defined parameters comprise one or more objective and/or penalty functions.

In some embodiments, the computing of the revised optimized coil array having the initial torsion comprises receiving inputs adapted to adjust torsion on the computed preliminary optimized coil array; and performing a second optimization based on the received inputs to provide the revised coil array having the initial torsion. In some embodiments, the inputs adapted to adjust the torsion of the coils in the preliminary optimized coil array include (i) the n>1 Fourier modes to unfix; (ii) the penalty function to address torsion on the preliminary optimized coil design; and/or (iii) the number of iterations to perform. In some embodiments, the number iterations to perform ranges from between about 10 to about 50. In some embodiments, the iteratively refining the revised optimized coil array until the target torsion of zero is achieved comprises receiving inputs adapted to further optimize the computed revised coil array; using the received inputs to perform a further optimization to provide a further updated coil array having a comparatively reduced torsion value; determining whether the updated coil array meets a predetermined target torsion value.

1. A method of generating a set of torsion-restricted free parameters which describe a design of one or more electromagnetic coils that are substantially planar, comprising:
(a) obtaining a set of preliminary non-planar free parameters, where the set of preliminary non-planar free parameters describe one or more non-planar coils;
(b) obtaining a total objective function, wherein the total objective function is derived from at least two penalty functions, wherein one of the at least two penalty functions is a torsion penalty function, and wherein the torsion penalty function has an initial weight;
(c) iteratively computing one or more torsion parameters, wherein the computation of each torsion parameter of the one or more torsion parameters comprises: (i) performing a torsion-restricted numerical optimization to generate a set of candidate torsion-restricted free parameters, and (ii) computing the torsion parameter based on the generated set of candidate torsion-restricted free parameters; and
(d) selecting the generated set of candidate torsion-restricted free parameters whose corresponding computed torsion parameter is less than a predetermined threshold value for torsion as the set of torsion-restricted free parameters;
wherein a first torsion-restricted numerical optimization performed is based on (i) the obtained set of preliminary non-planar free parameters, (ii) the obtained total objective function; and (iii) a predetermined numerical optimization algorithm; and wherein each subsequent torsion-restricted numerical optimization is based on (i) a revised total objective function having an increased weight of the torsion penalty function relative to the initial weight of the torsion penalty function in the total objective function; (ii) the set of candidate torsion-restricted parameters generated from the immediately preceding subsequent torsion-restricted numerical optimization; and (iii) the predetermined numerical optimization algorithm.

2. The method of claim 1, wherein the total objective function is derived from at least three penalty functions.

3. The method of claim 1, wherein the at least two penalty functions each correspond to a different quantity to penalize.

4. The method of claim 3, wherein the torsion penalty function corresponds to a torsion quantity to penalize.

5. The method of claim 3, wherein a second of the at least two penalty functions corresponds to a magnetic field error quantity to penalize.

6. The method of claim 3, wherein the different quantities to penalize are selected from the group consisting of torsion, magnetic field error, coil-to-plasma distance, coil curvature, and coil-to-coil spacing.

7. A method of generating a set of torsion-restricted free parameters which describe a design of one or more electromagnetic coils that are substantially planar, comprising:
(a) obtaining a set of preliminary non-planar free parameters, where the set of preliminary non-planar free parameters describe one or more non-planar coils;
(b) obtaining a total objective function, wherein the total objective function is derived from at least two penalty functions, wherein one of the at least two penalty functions is a torsion penalty function, and wherein the torsion penalty function has one or more initial parameters;
(c) iteratively computing one or more torsion parameters, wherein the computation of each torsion parameter of the one or more torsion parameters comprises: (i) performing a torsion-restricted numerical optimization to generate a set of candidate torsion-restricted free parameters, and (ii) computing the torsion parameter based on the generated set of torsion-restricted free parameters; and
(d) selecting the generated set of candidate torsion-restricted free parameters whose corresponding computed torsion parameter is less than a predetermined threshold value for torsion as the set of torsion-restricted free parameters;
wherein a first torsion-restricted numerical optimization performed is based on (i) the obtained set of preliminary non-planar free parameters, (ii) the obtained total objective function; and (iii) a numerical optimization algorithm; and wherein each subsequent torsion-restricted numerical optimization is based on (i) a revised total objective function having one or more altered parameters relative to the initial one or more parameters of the torsion penalty function in the total objective function; (ii) the set of candidate torsion-restricted parameters generated from the immediately preceding subsequent torsion-restricted numerical optimization; and (iii) the predetermined numerical optimization algorithm.

8. The method of claim 7, wherein the total objective function is derived from at least three penalty functions.

9. The method of claim 7, wherein the at least two penalty functions each correspond to a different quantity to penalize.

10. The method of claim 9, wherein the different quantities to penalize are selected from the group consisting of torsion, magnetic field error, coil-to-plasma distance, coil curvature, and coil-to-coil spacing.

11. A method of generating a set of torsion-restricted free parameters which describe a design of one or more electromagnetic coils that are substantially planar, comprising:
(a) obtaining a field-shaping coil system comprising a plurality of planar shaping coils, wherein the field-shaping coil system is adapted to magnetically confine a plasma;
(b) generating the set of torsion-restricted free parameters which describe the design of the one or more electromagnetic coils that are substantially planar, where the one or more electromagnetic coils that are substantially planar encircle and interlock the field-shaping coil system, wherein the set of torsion-restricted free parameters are generated by:
(i) obtaining a set of preliminary non-planar free parameters, where the set of preliminary non-planar free parameters describe one or more non-planar coils;
(ii) obtaining a total objective function, wherein the total objective function is derived from at least two penalty functions, wherein a first of the at least two penalty functions is a torsion penalty function, wherein the torsion penalty function has one or more initial parameters, and wherein a second of the at least two penalty functions is derived from one or more quantities to penalize, wherein the one or more quantities to penalize for the second of the at least two penalty functions are selected from the group consisting of a required current in the plurality of shaping coils, a required conductor length of the plurality of shaping coils, and a maximum magnetic field of the plurality of shaping coils;
(iii) iteratively computing one or more torsion parameters, wherein the computation of each torsion parameter of the one or more torsion parameters comprises: (a) performing a torsion-restricted numerical optimization to generate a set of candidate torsion-restricted free parameters, and (a) computing the torsion parameter based on the generated set of torsion-restricted free parameters; and
(iv) selecting the generated set of candidate torsion-restricted free parameters whose corresponding computed torsion parameter is less than a predetermined threshold value for torsion as the set of torsion-restricted free parameters;
wherein a first torsion-restricted numerical optimization performed is based on (a) the obtained set of preliminary non-planar free parameters, (b) the obtained total objective function; and (c) a numerical optimization algorithm; and wherein each subsequent torsion-restricted numerical optimization is based on (a) a revised total objective function having one or more altered parameters relative to the initial one or more parameters of the torsion penalty function in the total objective function; (b) the set of candidate torsion-restricted parameters generated from the immediately preceding subsequent torsion-restricted numerical optimization; and (c) the predetermined numerical optimization algorithm.

12. The method of claim 11, wherein each shaping coil of the plurality of shaping coils is planar.

13. The method of claim 11, wherein the field-shaping coil system comprises one or more field shaping units which define a void adapted to confine the plasma, wherein each field shaping unit comprises: (i) one or more structural mounting elements; and (ii) the plurality of shaping coils disposed on a surface of the one or more structural mounting elements, wherein the plurality of shaping coils do not interlock with each other, and where each shaping coil of the plurality of shaping coils do not individually encircle the plasma.

14. The method of claim 12, wherein each of the one or more field shaping units comprises between about 5 and about 100 shaping coils.

15. The method of claim 11, wherein the plurality of shaping coils is comprised of a superconducting material.
